(19) United States
(12) Patent Application Publication
(10) Pub. No.: US 2003/0208387 A1
(43) Pub. Date: Nov. 6, 2003

(54) On-line purchase of partially anonymous products

(76) Inventors: Jeffrey Russell, Odessa, TX (US); Kent Dooley, Odessa, TX (US); Michael Thomas, Spinnerstown, PA (US); Wayne Russell, Odessa, TX (US)

Correspondence Address: Todd Mattingly, Haynes & Boone, Suite 4300, 1000 Louisiana, Houston, TX, 77002-5012, US

(21) Appl. No.: 10/182,755

(22) PCT Filed: Feb. 8, 2001
(86) PCT No.: PCT/US01/04221

(51) Int. Cl. G06F 17/60

(52) U.S. Cl. 705/5

(57) ABSTRACT

The computerized on-line system with user (115), Internet (110), and host (105) is used for purchasing partially anonymous products. The full identity of the products are not provided until after the products are actually purchased.

### CROSS REFERENCE TO RELATED APPLICATIONS

The present application claims the benefit of the filing dates of U.S. provisional patent application serial No. 60/181,846, attorney docket number 25531.15, filed on Feb. 11, 2000, and U.S. provisional patent application serial No. 60/186,801, attorney docket number 25531.22, filed on Mar. 3, 2000, the disclosures of which are incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

This invention relates to the on-line purchase of products, more particularly, to the on-line purchase of airline tickets.

Conventional on-line systems for purchasing products provide a full identification of the product to the consumer during the on-line interaction, and prior to the actual purchase of the product by the consumer. As a result, such conventional on-line system for purchasing products often disclose more information than is necessary in order for the consumer to make an informed purchase. Furthermore, the complete disclosure of all of the available information for a product, including the seller identity, often negatively impacts the competitive advantage in offering products at a discount by disclosing sensitive information to competitors in the industry. Finally, consumers that have already purchased products at the full retail price are typically upset to learn that the very same products are subsequently being offered at a discount price.

The present invention is directed to overcoming or at least minimizing one or more of the limitations of the existing on-line systems for purchasing products.

### SUMMARY

According to one embodiment of the present invention, a computer implemented method of purchasing airline tickets is provided that includes entering one or more desired airline travel criteria, retrieving and displaying one or more available airline travel resources that approximately match the desired airline travel criteria, wherein at least a portion of the full identity of the airline travel resources are withheld, purchasing one or more of the available airline travel resources, and displaying the withheld portion of the full identity of the purchased airline travel resource.

According to another embodiment of the present invention, a computer program stored in a medium in machine readable format for a computer implemented method of purchasing airline tickets is provided that includes entering one or more desired airline travel criteria, retrieving and displaying one or more available airline travel resources that approximately match the desired airline travel criteria, wherein at least a portion of the full identity of the airline travel resources are withheld, purchasing one or more of the available airline travel resources, and displaying the withheld portion of the full identity of the purchased airline travel resource.

According to another embodiment of the present invention, a system for purchasing airline tickets is provided that includes a network, one or more users coupled to the network, and a host coupled to the users using the network. The host is adapted to: permit the users to enter one or more desired airline travel criteria, retrieve and display one or more available airline travel resources that approximately match the desired airline travel criteria, wherein at least a portion of the full identity of the airline travel resources are withheld, permit the users to purchase one or more of the available airline travel resources, and display the withheld portion of the full identity of the purchased airline travel resource after the purchase.

According to another embodiment of the present invention, a computer implemented method of purchasing airline tickets is provided that includes withholding at least a portion of the full identity of the airline ticket until after the purchase of the airline ticket.

According to another embodiment of the present invention, a computer implemented method of purchasing airline tickets is provided that includes generalizing at least a portion of the full identity of the airline ticket until after the purchase of the airline ticket.

According to another embodiment of the present invention, a computer program stored in a medium in a machine-readable format for a computer implemented method of purchasing airline tickets is provided that includes withholding at least a portion of the full identity of the airline ticket until after the purchase of the airline ticket.

According to another embodiment of the present invention, a computer program stored in a medium in a machine-readable format for a computer implemented method of purchasing airline tickets is provided that includes generalizing at least a portion of the full identity of the airline ticket until after the purchase of the airline ticket.

According to another embodiment of the present invention, a system for purchasing airline tickets is provided that includes a network, one or more users coupled to the network, and a host coupled to the users using the network adapted to withhold at least a portion of the full identity of the airline tickets until they are purchased by the users.

According to another embodiment of the present invention, a system for purchasing airline tickets is provided that includes a network, one or more users coupled to the network, and a host coupled to the users using the network adapted to generalize at least a portion of the full identity of the airline tickets until they are purchased by the users.

According to another embodiment of the present invention, a computer implemented method of purchasing products is provided that includes withholding at least a portion of the full identity of the product until after the purchase of the product.

According to another embodiment of the present invention, a computer implemented method of purchasing products is provided that includes generalizing at least a portion of the full identity of the product until after the purchase of the product.

According to another embodiment of the present invention, a computer program stored in a medium in a machine-readable format for a computer implemented method of purchasing products is provided that includes withholding at least a portion of the full identity of the product until after the purchase of the product.

According to another embodiment of the present invention, a computer program stored in a medium in a machine-readable format for a computer implemented method of purchasing products is provided that includes generalizing at least a portion of the full identity of the product until after the purchase of the airline ticket.

According to another embodiment of the present invention, a system for purchasing products is provided that includes a network, one or more users coupled to the network, and a host coupled to the users using the network adapted to withhold at least a portion of the full identity of the products until they are purchased by the users.

According to another embodiment of the present invention, a system for purchasing products is provided that includes a network, one or more users coupled to the network, and a host coupled to the users using the network adapted to generalize at least a portion of the full identity of the products until they are purchased by the users.

The present embodiments of the invention permit the on-line purchase of partially anonymous products. The full identity of the partially anonymous products are not provided until they are actually purchased by consumers. In this manner, the volume of on-line commerce is increased by providing sellers of such products with a competitive advantage.

### BRIEF DESCRIPTION OF THE DRAWINGS

FIG. 1 is a schematic illustration of an embodiment of an on-line system for purchasing partially anonymous products.

FIG. 2a is a flow chart of an embodiment of a portion of a method of purchasing partially anonymous products for use in the system of FIG. 1.

FIG. 2b is a flow chart of an embodiment of another portion of a method of purchasing partially anonymous products for use in the system of FIG. 1.

FIG. 2c is a flow chart of an embodiment of another portion of a method of purchasing partially anonymous products for use in the system of FIG. 1.

FIG. 2d is a flow chart of an embodiment of another portion of a method of purchasing partially anonymous products for use in the system of FIG. 1.

FIG. 3 is an illustration of an embodiment of a graphical user interface permitting a user to enter desired to and from flight data.

FIG. 4 is an illustration of an embodiment of a graphical user interface for displaying matching available flight resources.

FIG. 5 is an illustration of an embodiment of a graphical user interface for displaying selected flights, including fare information, as well as lowest-cost alternatives, including fare information, but lacking full detail.

FIGS. 6a-6c are illustrations of an exemplary embodiment of a website that permits a user to purchase partially anonymous products such as airline tickets.

FIG. 7 is an illustration of an exemplary embodiment of the website of FIGS. 6a-6c after the user has elected to login to the website using a user name and password.

FIG. 8 is an illustration of an exemplary embodiment of the website of FIG. 7 after the user has logged in, in which the user may then enter an itinerary and then request the website to show the user the discount negotiated fares for the itinerary.

FIGS. 9a and 9b are illustrations of the website of FIG. 8 after the user has requested the website to display the discount negotiated fares for the itinerary in which the user may request the website to research selected fares.

FIGS. 10a and 10b are illustrations of the website of FIGS. 9a and 9b after the user has requested the website to research selected fares in which the user may select the selected fare or an alternative fare for adding to the user's selected itinerary.

FIG. 11 is an illustration of the website of FIGS. 10a and 10b after the website has selected a selected fare for addition to the user's current itinerary in which the user may book the current itinerary.

FIGS. 12a, 12b, 12c and 12d are illustrations of the website of FIG. 11 after the user has selected the current itinerary for booking in which the user may purchase the selected itinerary using the website.

FIGS. 13a and 13b are illustrations of the website of FIG. 11 after the user has selected the current itinerary for booking in which the user may purchase the selected itinerary by calling a call center.

### DETAILED DESCRIPTION OF THE ILLUSTRATIVE EMBODIMENTS

An on-line system for purchasing partially anonymous products is provided that permits a consumer to interactively purchase products, whose full identity is at least partially hidden until the consumer actually purchases the product, over the Internet. In this manner, competitive information such as, for example, the product seller, is withheld from display until an actual purchase is made. In this manner, the disclosure of sensitive information regarding the details of products is prevented from disclosure until and unless the product is actually purchased. This protects and maintains the competitive advantage of selling low-cost products over the Internet. Furthermore, consumers that have already purchased products at the full retail price may be upset to learn that the very same product is subsequently being offered at a discount. Therefore, the present system prevents these consumers from being upset by the later offered discount prices for products. In a preferred implementation, the consumer is provided with sufficient details regarding such low-cost products in order to make an informed buying decision; but certain sensitive information is withheld until an actual purchase is made. The present system is preferably used to sell airline tickets. However; more generally, the present system may be adapted to sell any product over the Internet.

In a preferred embodiment, the present system is embodied by the on-line interactive system for purchasing White Label™ airline tickets using the Farebeater™ airline reservation system available at the website http://www.1travel.com. White Label™ fares are preferably the lowest-discounted flights available from a selected airline. In a preferred embodiment, White Label™ fares are fares on major U.S. and international airlines where the prices are so low that the airlines have asked 1travel.com not to reveal the name of their airline and certain flight specifications. The airlines typically want to remain anonymous on these discounted fares as not to upset other passengers who have paid a higher full price for their airline tickets. Full flight details preferably are made available immediately after the airline tickets have been purchased.

Using the Farebeater™ airline reservation system, a consumer can, for example, search for flights by entering the cities of travel and flight dates into the Farebeater™ search form. White Label™ fare flights are preferably automatically offered to the consumer when availability matches the requested travel itinerary. Currently 1travel.com offers thousands of White Label™ fare flights, in conjunction with 2 million consolidator airfares and over 20 million regular published fares. Typically, consumers can save up to 80% off of full, published airfares.

In a preferred embodiment, White Label™ fares do not provide the consumer with all of the details associated with the flight until after the consumer purchases the tickets. However, preferably, enough information is given to the consumer to enable the consumer to make an informed and safe buying decision up front.

In a preferred embodiment, when a White Label™ fare flight is available, the consumer is shown the approximate departure and arrival times (morning, afternoon, evening, night), the number of connections, the trip duration, ticket restrictions and, most importantly, the complete price.

In a preferred embodiment, the flight times for a White Label™ fare flight are shown with generalized departure and arrival times. For example, if the actual departure time is scheduled for 8 am, the White Label™ fare departure will be listed as morning. White Label™ fare flight times preferably include: (1) Morning—for actual departure or arrival times of 6 AM to 11 AM; (2) Afternoon—for actual departure or arrival times of 11 AM to 4 PM; (3) Evening—for actual departure or arrival times of 4 PM to 10 PM; and (4) Overnight—for actual departure or arrival times of 10 PM to 6 AM.

Stop over cities for White Label™ fare flights are preferably designated by “TBA,” the initials “TBA” stand for “to be announced.” White Label™ fares preferably show the number of stops associated with the flight. But, the consumer will not be informed of where the flight stops until the consumer receives the final confirmed itinerary. The stop over cities are hidden as another way to protect the anonymity of the airlines offering the discounted fares.

In a preferred embodiment, when the Farebeater™ reservation system performs a search, it automatically checks availability on all published fares, consolidator fares, sale fares and White Label™ fares. The available flights are preferably sorted from the lowest to the highest price. The consumer can then choose the flight that best suits the consumer. With the purchase of a White Label™ fare ticket, the consumer preferably receives an instant confirmation outlining all the details of the White Label™ fare flight including the name of the airline, exact flight times and any stop over cities.

In several alternative embodiments, White Label™ fares may include any or all fares. For example, the White Label™ fares may include negotiated lowest-price fares, non-negotiated fares, consolidator fares, discounted fares, and/or published fares. In this manner, more generally, at least a portion of the full flight information for at least a portion of the available fares is generalized and/or withheld from the consumer until actually purchased.

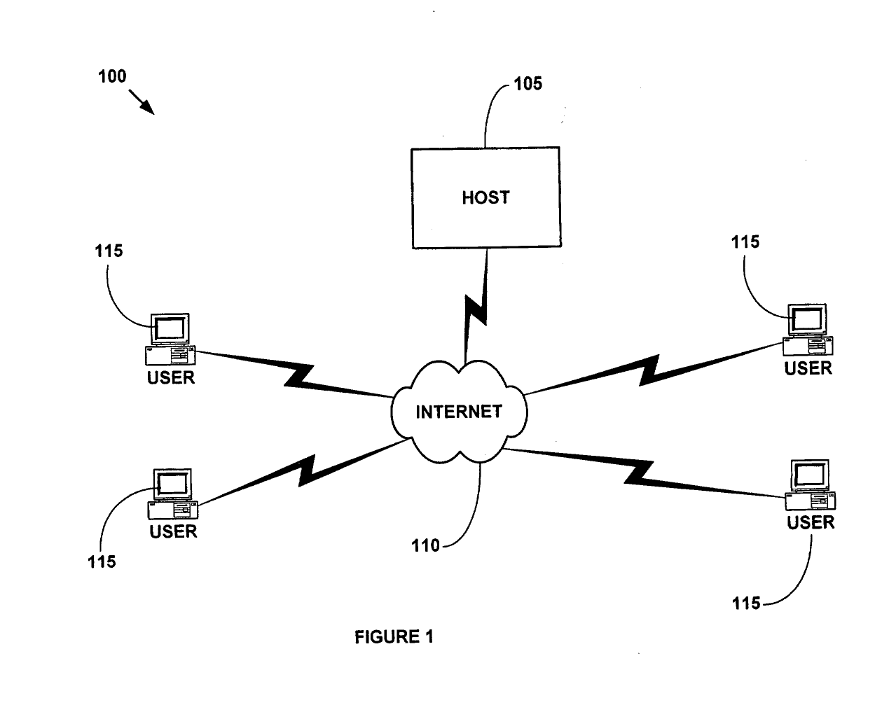

As illustrated in FIG. 1, in a preferred embodiment, a system 100 for purchasing partially anonymous products includes a host 105, the Internet 110, and one or more users 115. In a preferred embodiment, the system 100 is used to permit one or more of the users 115 to purchase products using the host 105. In a preferred embodiment, the full identity of at least some of the purchased products are withheld until after the actual purchase of the products.

The host 105 may comprise any number of conventional hosts suitable for hosting an interactive communication between one or more users coupled to the host over a network. In a preferred embodiment, the host 105 is a web host that includes a web server and one or more file servers. In a preferred embodiment, the host 105 is the website http://www.1travel.com.

The Internet 110 is coupled between the host 105 and the users 115. In several alternative embodiments, the Internet may be replaced or augmented by an Intranet, wide-area-network, and/or a local-area-network.

The users 115 are coupled to the Internet 110. The users 115 may be any number of conventional commercially available user interface devices for accessing and interacting with the Internet 110, or other network.

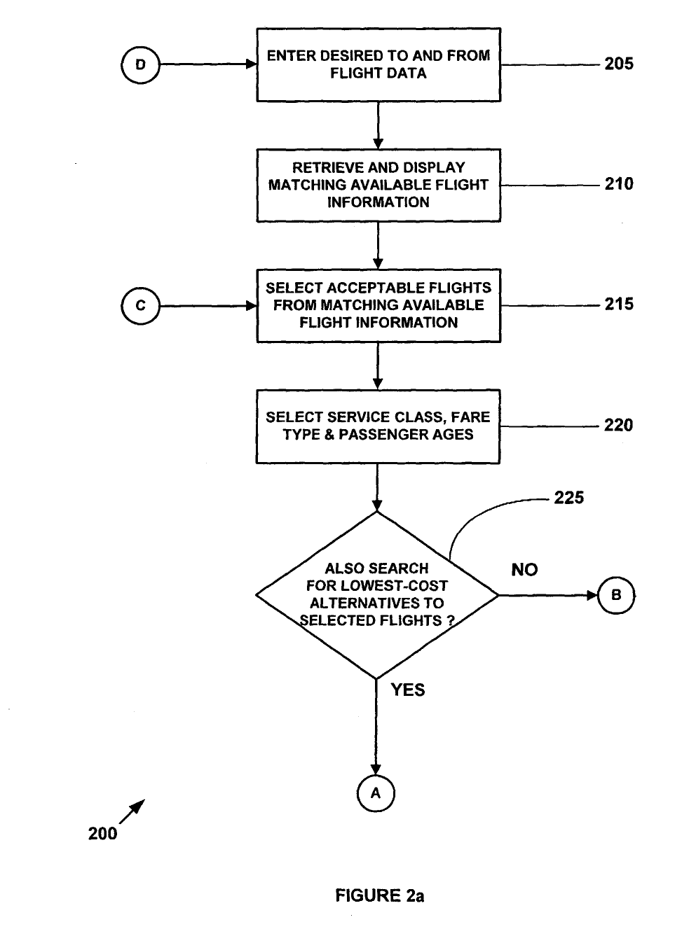

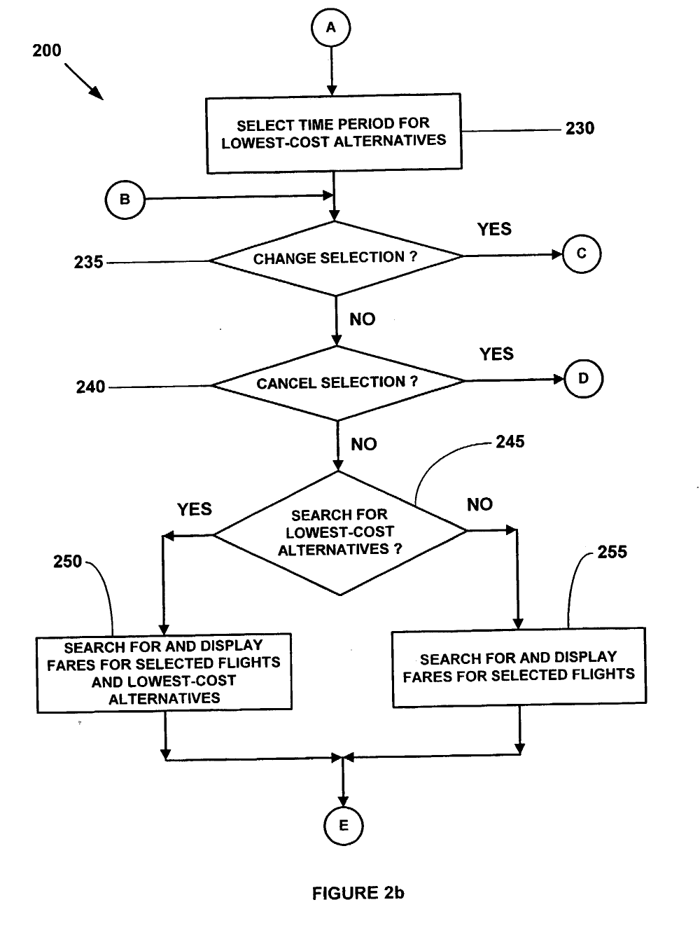

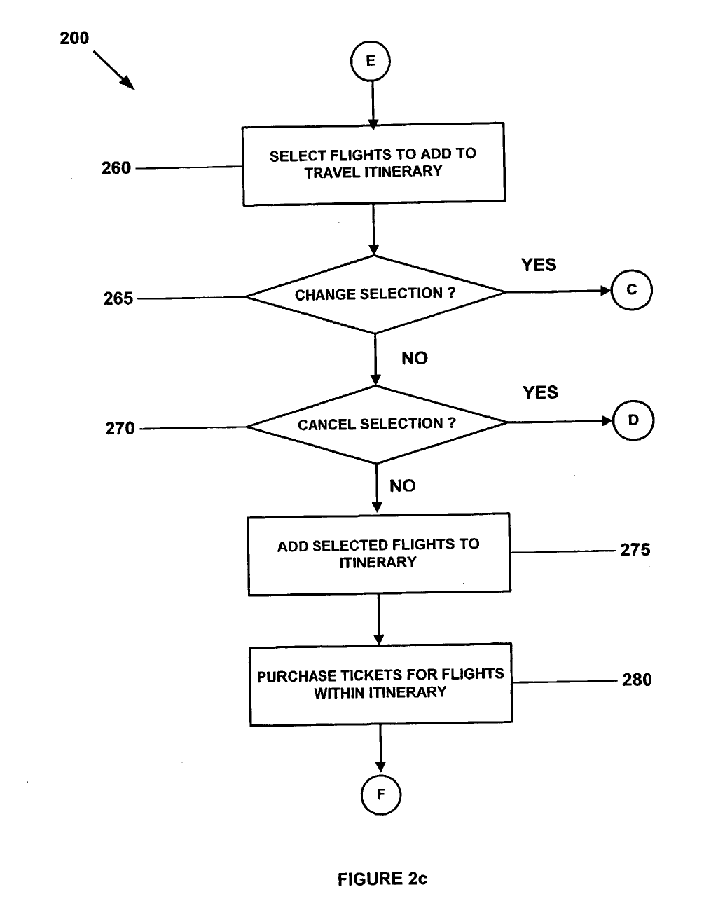

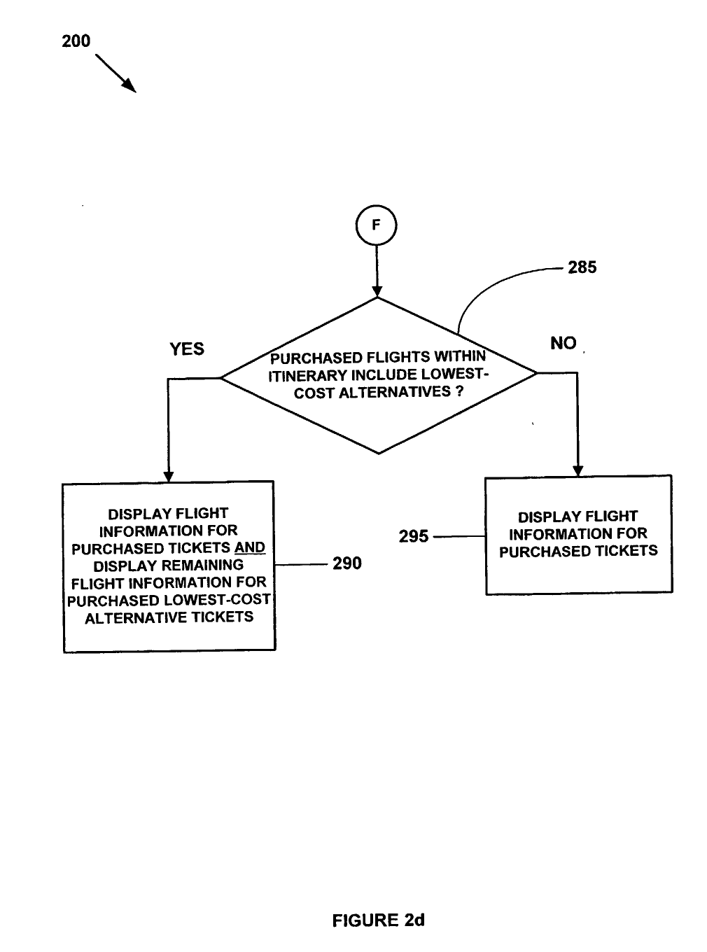

Referring to FIGS. 2a, 2b, 2c, and 2d, a preferred embodiment of a method 200 for purchasing partially anonymous products includes the steps of: entering desired to and from flight data in step 205; retrieving and displaying matching available flight resource information in step 210; selecting acceptable flights from the matching available flight resource information in step 215; selecting the service class, fare type & passenger ages in step 220; optionally electing to also search for lowest-cost alternatives to the selected acceptable flights in step 225; optionally selecting a permissible time period for the lowest-cost alternatives in step 230; optionally changing the selected acceptable flights in step 235; optionally canceling the selection of acceptable flights in step 240; determining if the user requested a search for lowest-cost alternatives in step 245; optionally searching for and displaying fares for the selected acceptable flights and the lowest-cost alternatives in step 250; optionally searching for and displaying fares for the selected acceptable flights in step 255; selecting the flights to add to the travel itinerary in step 260; optionally changing the selected flights in step 265; optionally canceling the selected flights in step 270; adding the selected flights to the travel itinerary in step 275; purchasing the tickets for the travel itinerary in step 280; determining if the purchased tickets in the travel itinerary include lowest-cost alternatives in step 285; optionally displaying flight information for the purchased tickets and displaying all of the flight information for the purchased lowest-cost alternative tickets in step 290; and optionally displaying flight information for the purchased tickets in step 295.

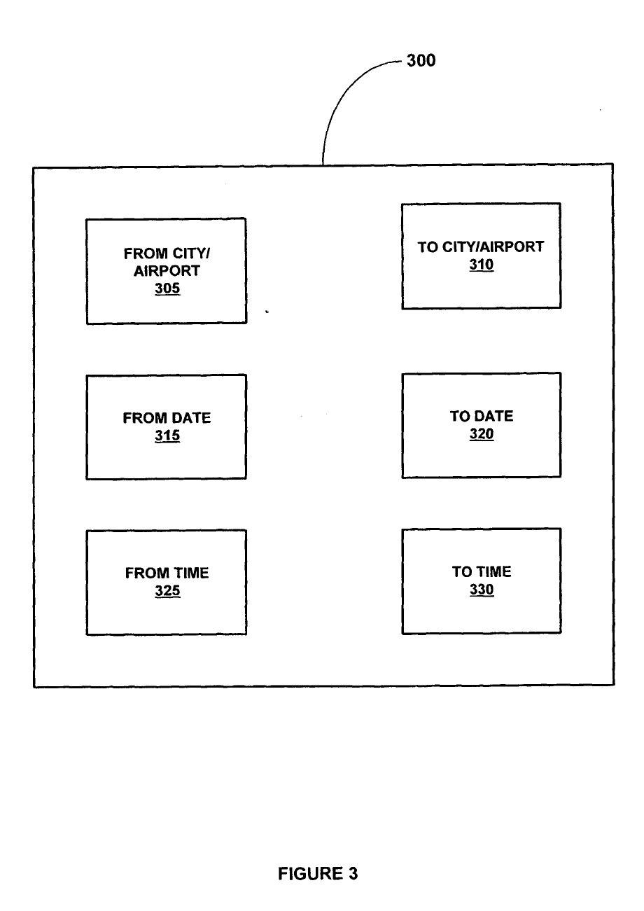

As illustrated in FIG. 3, in a preferred embodiment, in step 205, the user 115 enters the desired to and from flight data 300 for the airline travel. In a preferred embodiment, the desired flight data 300 includes one or more of the following: the city/airport 305 that the user 115 will depart from, the city/airport 310 that the user 115 will arrive at, the date 315 of departure, the date 320 of arrival, the time 325 of departure, and the time 330 of arrival.

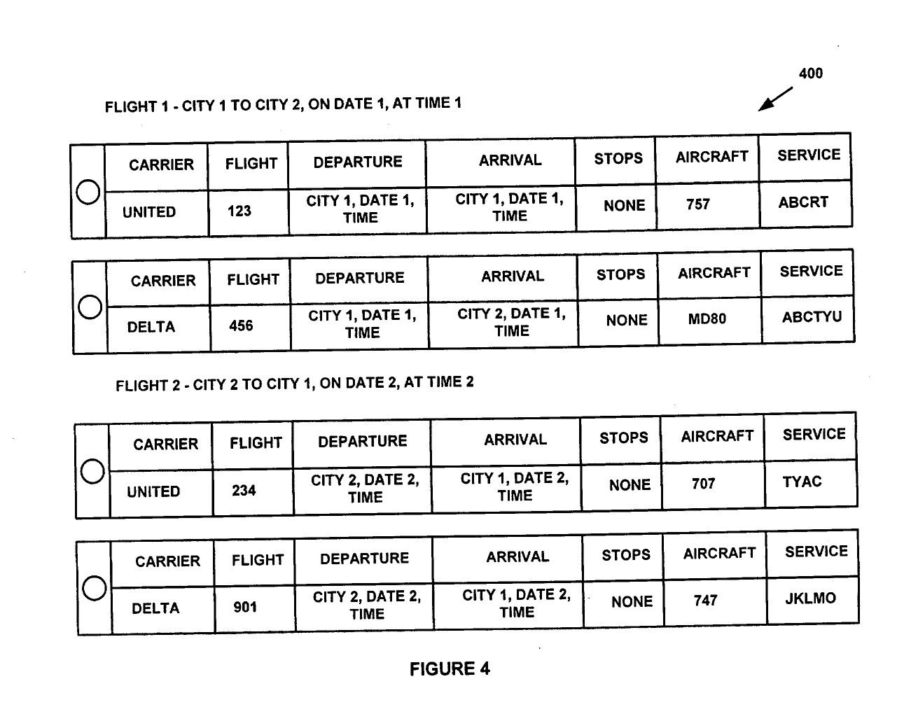

As illustrated in FIG. 4, in a preferred embodiment, in step 210, the host 105 then retrieves and displays information 400 regarding the available flights that substantially match the travel criteria provided by the user 115 in step 205. In a preferred embodiment, the information 400 includes the available flights from the departure city (City 1) to the arrival city (City 2) and the available return flights from the arrival city (City 2) to the departure city (City 1). In a preferred embodiment, the information provided for each available flight includes: (1) the name of the airline carrier; (2) the number of the flight; (3) the departure airport/city, date, and time; (4) the arrival airport/city, date, and time; (5) the stopover cities/airports; (6) the type of aircraft; (7) and the service code for the flight.

In several alternative embodiments, in step 210, at least a portion of the information 400 is withheld and/or generalized.

In a preferred embodiment, in step 215, the user 115 selects the acceptable flights from the information 400 regarding the available flights.

In a preferred embodiment, in step 220, the user 115 selects the service class, the fare type & the ages of passengers. In a preferred embodiment, the available options for the service class include: coach, business and first class. In a preferred embodiment, available options for the fare type include: lowest fare; lowest non-penalty; lowest unrestricted; and full fare.

In a preferred embodiment, in step 225, the user 115 may then request the host 105 to also search for the lowest-cost alternatives to the flights selected in step 215. In an exemplary embodiment, the ability to search for the lowest-cost alternatives to the flights selected in step 215 is limited to coach class tickets. In this manner, the host 105 will then search for the lowest-cost alternatives to the flights selected in step 215. In a preferred embodiment, the details describing one or more of the lowest-cost alternatives are at partially omitted until they are purchased by the user 115. In a preferred embodiment, the lowest-cost alternatives are White Label™ fare alternatives as provided by the Farebeater™ reservation system available at the website http://www.onetravel.com.

In a preferred embodiment, in step 230, the user 115 may then select the permissible variation in the flight travel days for the travel itinerary. In an exemplary embodiment, the permissible variation in the flight travel days ranges from 9 days prior to the selected dates to 9 days after the selected date. In this manner, the user 115 can vary the scope of the search for lowest-cost alternatives.

In a preferred embodiment, in step 235, the user 115 can choose to changes the selected acceptable flights by returning to step 215.

In a preferred embodiment, in step 240, the user 115 can choose to cancel the selected acceptable flights and return to step 205.

In a preferred embodiment, in step 245, the host 105 determines if the user 115 requested the host 105 to also search for the lowest-cost alternatives.

In a preferred embodiment, in step 250, if the user 115 requested the host 105 to also search for the lowest-cost alternatives, then the host 105 displays the fares for the selected flights and the lowest-cost alternatives.

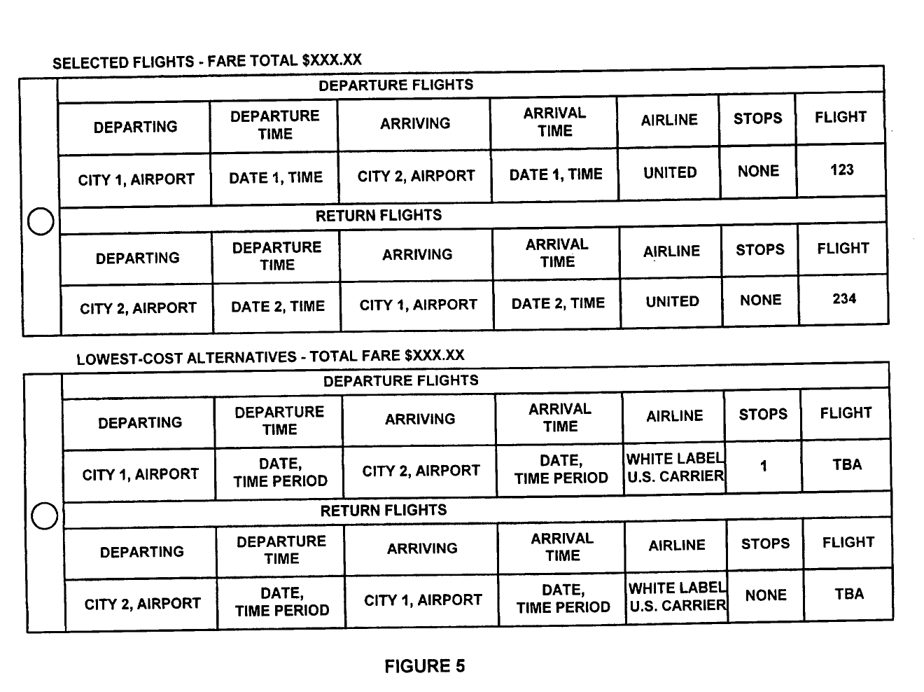

As illustrated in FIG. 5, in a preferred embodiment, in step 250, the lowest-cost alternatives include one or more departure and/or return flights for which at least a portion of the details are withheld and/or generalized until purchased by the user 115. In an preferred embodiment, actual departure and arrival times for the lowest-cost alternatives are replaced with a generalized indication of the departure time selected from: (1) Morning—for actual flight times between 6 AM and 11 AM; (2) Afternoon—for actual flight times between 11 AM and 4 PM; (3) Evening—for actual flight times between 4 PM and 10 PM; and (4) Overnight—for actual flight times between 10 PM and 6 AM. In a preferred embodiment, the identity of airline carrier is omitted. In a preferred embodiment, the number of stopover cities is provided; however, the identity of the stopover cities is withheld. In a preferred embodiment, the flight number is withheld by using the designation TBA (for to be announced). In this manner, the full details for some of the lowest-cost alternative flights are withheld or generalized. However, in a preferred embodiment, enough information regarding the lowest-cost alternative is provided to permit the user 115 to make an informed purchasing decision.

In several alternative embodiments, in step 250, at least a portion of the full flight information for the selected flights is generalized and/or withheld.

In a preferred embodiment, in step 255, if the user 115 requested the host 105 not to also search for the lowest-cost alternatives, then the host 105 displays the fares for the selected flights.

In several alternative embodiments, in step 255, at least a portion of the full flight information for the selected flights is generalized and/or withheld.

In a preferred embodiment, in step 260, the user 115 selects flights displayed in steps 250 or 255 to add the travel itinerary.

In a preferred embodiment, in step 265, the user 115 can choose to changes the selected acceptable flights by returning to step 215.

In a preferred embodiment, in step 270, the user 115 can choose to cancel the selected acceptable flights and return to step 205.

In a preferred embodiment, in step 275, the user 115 can then add the flights selected in step 260 to the travel itinerary.

In a preferred embodiment, in step 280, the user 115 can then purchase the tickets within the travel itinerary.

In a preferred embodiment, in step 285, the host 105 determines if the purchased travel itinerary for the user 115 includes a lowest-cost alternative having withheld and/or generalized information.

In a preferred embodiment, in step 290, if the purchased travel itinerary for the user 115 includes a lowest-cost alternative having withheld and/or generalized information, the host 105 displays the complete travel itinerary for the user 105 including the full details for the lowest-cost alternative that had withheld and/or generalized information. In this manner, the previously withheld and/or generalized flight information for the lowest-cost alternative is revealed to the user 115 by the host 105 once the lowest-cost alternative has been purchased by the user 115.

In several alternative embodiments, in step 290, if the purchased travel itinerary for the user 115 includes a lowest-cost alternative having withheld and/or generalized information, the host 105 further displays the complete travel itinerary for the user 105 including any information that may have been generalized and/or withheld in steps 210, 250, or 255.

In a preferred embodiment, in step 295, if the purchased travel itinerary for the user 115 did not include a lowest-cost alternative having withheld and/or generalized information, the host 105 displays the complete travel itinerary for the user 105.

In several alternative embodiments, in step 295, if the purchased travel itinerary for the user 115 did not include a lowest-cost alternative having withheld and/or generalized information, the host 105 displays the complete travel itinerary for the user 105, including any information that may have been generalized and/or withheld in steps 210, 250, or 255.

In several alternative embodiments of the method 200, the web host 105 is configured to permit the web master to optionally configure the system 100 to conceal and/or generalize the airline name, and/or the flight numbers, and/or the flight schedule information for a selected flight. In this manner, the operation of the system 100 can be further tailored to suit the particular needs of the web host 105.

In several alternative embodiments of the method 200, the web host 105 is configured to permit the web master to optionally configure the system 100 to withhold and/or generalize all, or a portion, of the full flight information for all, or a portion, of the available fares. In this manner, all, or a portion, of the full flight information for all, or a portion, of the available fares can be generalized and/or withheld until an actual purchase is made.

A computer implemented method of purchasing airline tickets has been described that includes: entering one or more desired airline travel criteria, retrieving and displaying one or more available airline travel resources that approximately match the desired airline travel criteria, wherein at least a portion of the full identity of the airline travel resources are withheld, purchasing one or more of the available airline travel resources, and displaying the withheld portion of the full identity of the purchased airline travel resource. In a preferred embodiment, the airline travel criteria include a permissible variation in a desired travel date. In a preferred embodiment, the withheld portion of the full identity of the purchased airline travel resource is selected from the group consisting of the identity of the airline, the stopover airports, the departure times, the arrival times, and the flight number. In a preferred embodiment, the displayed available airline travel resources include a time period for departure and arrival. In a preferred embodiment, the time period for departure and arrival is selected from the group consisting of morning, afternoon, evening, and overnight.

A computer program stored in a medium in machine readable format for a computer implemented method of purchasing airline tickets has also been described that includes entering one or more desired airline travel criteria, retrieving and displaying one or more available airline travel resources that approximately match the desired airline travel criteria, wherein at least a portion of the full identity of the airline travel resources are withheld, purchasing one or more of the available airline travel resources, and displaying the withheld portion of the full identity of the purchased airline travel resource. In a preferred embodiment, the airline travel criteria include a permissible variation in a desired travel date. In a preferred embodiment, the withheld portion of the full identity of the purchased airline travel resource is selected from the group consisting of the identity of the airline, the stopover airports, the departure times, the arrival times, and the flight number. In a preferred embodiment, the displayed available airline travel resources include a time period for departure and arrival. In a preferred embodiment, the time period for departure and arrival is selected from the group consisting of morning, afternoon, evening, and overnight.

A system for purchasing airline tickets has also been described that includes a network, one or more users coupled to the network, and a host coupled to the users using the network. The host is adapted to: permit the users to enter one or more desired airline travel criteria, retrieve and display one or more available airline travel resources that approximately match the desired airline travel criteria, wherein at least a portion of the full identity of the airline travel resources are withheld, permit the users to purchase one or more of the available airline travel resources, and display the withheld portion of the full identity of the purchased airline travel resource after the purchase. In a preferred embodiment, the airline travel criteria include a permissible variation in a desired travel date. In a preferred embodiment, the withheld portion of the full identity of the purchased airline travel resource is selected from the group consisting of the identity of the airline, the stopover airports, the departure times, the arrival times, and the flight number. In a preferred embodiment, the displayed available airline travel resources include a time period for departure and arrival. In a preferred embodiment, the time period for departure and arrival is selected from the group consisting of morning, afternoon, evening, and overnight.

A computer implemented method of purchasing airline tickets has also been described that includes withholding at least a portion of the full identity of the airline ticket until after the purchase of the airline ticket.

A computer implemented method of purchasing airline tickets has also been described that includes generalizing at least a portion of the full identity of the airline ticket until after the purchase of the airline ticket.

A computer program stored in a medium in a machine-readable format for a computer implemented method of purchasing airline tickets has also been described that includes withholding at least a portion of the full identity of the airline ticket until after the purchase of the airline ticket.

A computer program stored in a medium in a machine-readable format, for a computer implemented method of purchasing airline tickets has also been described that includes generalizing at least a portion of the full identity of the airline ticket until after the purchase of the airline ticket.

A system for purchasing airline tickets has also been described that includes a network, one or more users coupled to the network, and a host coupled to the users using the network adapted to withhold at least a portion of the full identity of the airline tickets until they are purchased by the users.

A system for purchasing airline tickets has also been described that includes a network, one or more users coupled to the network, and a host coupled to the users using the network adapted to generalize at least a portion of the full identity of the airline tickets until they are purchased by the users.

A computer implemented method of purchasing products has also been described that includes withholding at least a portion of the full identity of the product until after the purchase of the product.

A computer implemented method of purchasing products has also been described that includes generalizing at least a portion of the full identity of the product until after the purchase of the product.

A computer program stored in a medium in a machine-readable format, comprising a computer implemented method of purchasing products has also been described that includes withholding at least a portion of the full identity of the product until after the purchase of the product.

A computer program stored in a medium in a machine-readable format for a computer implemented method of purchasing products has also been described that includes generalizing at least a portion of the full identity of the product until after the purchase of the product.

A system for purchasing products has also been described that includes a network, one or more users coupled to the network, and a host coupled to the users using the network adapted to withhold at least a portion of the full identity of the products until they are purchased by the users.

A system for purchasing products has also been described that includes a network, one or more users coupled to the network, and a host coupled to the users using the network adapted to generalize at least a portion of the full identity of the products until they are purchased by the users.

In a preferred embodiment, the system 100 and method 200 are implemented using the following software:

===========================================
=====================================
Archive file: /tlx003/home/users/cert/Makefile
retrieving revision 4.22
retrieving revision 4.21
diff -r4.22 -r4.21
197,202d196

| | |
|---|---|
| < | -mkdir $(DEST)/sitemaint/aircode |
| < | -mkdir $(DEST)/sitemaint/aircode/cgi-bin |

===========================================
=====================================
Archive file: /tlx003/home/users/cert/air/av.cpp
retrieving revision 4.39
retrieving revision 4.35
diff -r4.39 -r4.35
63c63
< static char *rcsid = “$Header: /tlx003/home/users/cert/air/av.cpp 4.39
1999/11/16 22:40:48 cmattair Exp $”;
---
> static char *rcsid = “$Header: /tlx003/home/users/cert/air/av.cpp 4.35
1999/09/27 14:16:48 cmattair Exp $”;
1304,1312c1296,1299
<

| | |
|---|---|
| < | if (rate_p->flags.white_label) { |

| | |
|---|---|
| < | sprintf(temp, “_%s”, rate_p->airline_code); |
| < | Data->Add)“Airline”, temp); |

| | |
|---|---|
| < | } else { |

| | |
|---|---|
| < | Data->Add( “Airline”, rate_p->airline_code); |

| | |
|---|---|
| < | } |

| | |
|---|---|
| < | Data->Add( “WhiteLabel”, rate_p->flags.white_label ); |
| < | |
| --- | |
| > | Data->Add( “Airline”, rate_p->white_label |

| | |
|---|---|
| > | ? EncodeConsolidator(rate_p- >airline_code) |
| > | : rate_p,->airline_code); |

| | |
|---|---|
| > | Data->Add( “WhiteLabel”, rate_p->white_label ); |

1361,1364c1347,1348

| | |
|---|---|
| < | Fielder.PutField( rate_p->flags.white_label ); |
| < | Fielder.PutField( rate_p->flags.hide_flight ); |
| < | Fielder.PutField( rate_p->flags.hide_time ); |
| < | Fielder.PutField( rate_p->flags.white_label |
| --- | |
| > | Fielder.PutField( rate_p->white_label ); |
| > | Fielder.PutField( rate_p->white_label |

===========================================
=====================================
Archive file: /tlx003/home/users/cert/air/fdetails.cpp
retrieving revision 4.10
retrieving revision 4.9
diff -r4.10 -r4.9
18c18
< static char *rcsid = “$Header: /tlx003/home/users/cert/air/fdetails.cpp 4.10
1999/11/08 17:15:08 cmattair Exp $”;
---
> static char *rcsid = ”$Header: /tlx003/home/users/cert/air/fdetails.cpp 4.9
1999/08/31 19:17:39 cmattair Exp $”;
24c24
< static rate_flags flags;
---
> static int white_label = 0;
65,66d64
< char temp[128];
< int segs_minus_2;
87a86
> white_label = pd.Rate.white_label;
137,139d135

| | |
|---|---|
| < | flags = pd.Rate.flags; |
| < | if (flags.hide_time && (segs_minus_2 = objFlightDtls.SegCount - 2) < 0) |

| | |
|---|---|
| < | flags.hide_time = 4; |

145,154c141,143

| | |
|---|---|
| < | if (flags.white_label) { |

| | |
|---|---|
| < | sprintf(temp, “_%s”, objFlightDtls.Details[j].Carrier); |
| < | Data->Add(“Airline”, temp); |

| | |
|---|---|
| < | } else { |

| | |
|---|---|
| < | Data->Add( “Airline”, objFlightDtls.Details[j].Carrier ); |

| | |
|---|---|
| < | } |
| < | if (flags.hide_flight) { |

| | |
|---|---|
| < | sprintf(temp, “_%s”, objFlightDtls.Details[j].Flight ); |
| < | Data->Add( “FlightNumber”, temp); |

| | |
|---|---|
| < | } else { |
| --- | |
| > | Data->Add( “Airline”, (white_label) |

| | |
|---|---|
| > | ? EncodeConsolidator(objFlightDtls.Details[j].Carrier) |
| > | : objFlightDtls.Details[j].Carrier ); |

156,164c145,146

| | |
|---|---|
| < | } |

| | |
|---|---|
| < | if (flags.hide_time) { |
| < | sprintf(temp, “_%d”, |

| | |
|---|---|
| < | TmWp.NumberTime(objFlightDtls.Details[j].DepDate)); |

| | |
|---|---|
| < | Data->Add(“DepDateTime”, temp); |
| < | sprintf(temp, “_%d”, |

| | |
|---|---|
| < | TmWp.NumberTime(objFlightDtls.Details[j].ArvDate)); |

| | |
|---|---|
| < | Data->Add(“ArvDateTime”, temp); |

| | |
|---|---|
| < | } else { |
| --- | |
| > | Data->Add( “From”, objFlightDtls.Details[j].Board ); |
| > | Data->Add( “To”, objFlightDtls.Details[j].Off ); |

167,182d148

| | |
|---|---|
| < | } |
| < | if (flags.hide_time & 1) { |

| | |
|---|---|
| < | sprintf(temp, “_%s”, objFlightDtls.Details[j].Off); |
| < | Data->Add(“To”, temp); |

| | |
|---|---|
| < | } else { |

| | |
|---|---|
| < | Data->Add( “To”, objFlightDtls.Details[j].Off ); |

| | |
|---|---|
| < | } |
| < | if (flags.hide_time & 2) { |

| | |
|---|---|
| < | sprintf(temp, “_%s”, objFlightDtls.Details[j].Board); |
| < | Data->Add(“From”, temp); |

| | |
|---|---|
| < | } else { |

| | |
|---|---|
| < | Data->Add( “From”, objFlightDtls.Details[j].Board ); |

| | |
|---|---|
| < | } |
| < | if (flags.hide_time & 3) |

| | |
|---|---|
| < | flags.hide_time = (j != segs_minus_2) ? 3 : 2; |
| < | |

184c150

| | |
|---|---|
| < | if (objFlightDtls.Details[j].RealAirline[0] && !flags.white_label) |
| --- | |
| > | if (objFlightDtls.Details[j].RealAirline[0] && !white_label) |

===========================================
=====================================
Archive file: /tlx0033/home/users/cert/bk/bk.cpp
retrieving revision 472
retrieving revision 4.60
diff -r4.72 -r4.60
43c43
< static char *rcsid = “$Header: /tlx003/home/users/cert/bk/bk.cpp 4.72
1999/12/07 23:07:17 cmattair Exp $”;
---
> static char *rcsid = “$Header: /tlx003/home/users/cert/bk/bk.cpp 4.60
1999/08/16 22:37:42 jrea Exp $”;
292c292

| | |
|---|---|
| < | rate_flags save_flags; |
| --- | |
| > | |

1256,1259d1243

| | |
|---|---|
| < | save_flags = ItinState.Rate.flags; |
| < | ItinState.Rate.flags.white_label = 0; |
| < | ItinState.Rate.flags.hide_time = 0; |
| < | ItinState.Rate.flags.hide_flight = 0; |

1261,1262d1244

| | |
|---|---|
| < | ItinState.Rate.flags = save_flags; |
| < | } |

1313c1295

| | |
|---|---|
| < | EmailItinerary( EmailAddress, &ItinState, Data, “bkfail.ml”, FALSE, |

TRUE );
---

| | |
|---|---|
| > | EmailItinerary( EmailAddress, &ItinState, Data, “bkfail.ml” ); |

1335c1317

| | |
|---|---|
| < | EmailItinerary( EmailAddress, &ItinState, Data, “bkfail.ml”, FALSE, |

TRUE);
---

| | |
|---|---|
| > | EmailItinerary( EmailAddress, &ItinState, Data, “bkfail.ml” ); |

===========================================
=====================================
Archive file: /tlx003/home/users/cert/callcenter/cclookup.cpp
retrieving revision 4.10
retrieving revision 4.5
diff -r4.10 -r4.5
36,38d35
< #ifndef LINT
< static char *rcsid = “$Header:
/tlx003/home/users/cert/callcenter/cclookup.cpp 4.10 1999/11/08 17:15:23
cmattair Exp $”;
< #endif
293d284

| | | |
|---|---|---|
| < | rate_flags | flags = {0}; |

349c340

| | |
|---|---|
| < | AirCollection( &Itin.Seg[0].Air, &flags, Data ); |
| --- | |
| > | AirCollcction( &Itin.Seg[0].Air, Data ); |

===========================================
=====================================
Archive file: /tlx003lhome/users/cert/common/common.cpp
retrieving revision 4.34
retrieving revision 4.23
diff -r4.34 -r4.23
14d13
< #include “db/consolidator.h”
17c16
< static char *rcsid = “$Header: /tlx003/home/users/cert/common/common.cpp
4.34 1999/11/17 07:57:09 cmattair Exp $”;
---
> static char *rcsid = “$Header: /tlx003/home/users/cert/common/common.cpp
4.23 1999/08/12 19:57:45 cmattair Exp $”;
44d42

| | |
|---|---|
| < | flights_minus_2, |
| 47d44 | |
| < | rate_flags flags; |

119,122d115

| | | |
|---|---|---|
| < | Data->Add( “white_label”, | pd->Rate.flags.white_label ); |
| < | Data->Add( “hide flight”, | pd->Rate.flags.hide_flight ); |
| < | Data->Add( “hide time”, | pd->Rate.flags.hide_time ); |

166,170d153

| | |
|---|---|
| < | flags = pd->Rate.flags; |
| < | if (flags.hide_time |

| | |
|---|---|
| < | && (flights_minus_2 = pd->Trip[i][j].m_NumFlights - 2) < 0) |

| | |
|---|---|
| < | flags.hide time = 4; |

<
172,176c155,157

| | |
|---|---|
| < | flight_to_collection(Data, FlightRecord, pd->ClassType, |

| | |
|---|---|
| < | &flags, Flight); |

| | |
|---|---|
| < | if (flags.hide_time & 3) |

| | |
|---|---|
| < | flags.hide_time = (k != flights_minus_2) ? 3 : 2; |
| --- | |
| > | { |
| > | flight_to_collection(Data, FlightRecord, pd->ClassType, Flight); |

1252,1255d1237

| | |
|---|---|
| < | if (flags->white_label) { |

| | |
|---|---|
| < | sprintf(under “_%s”, flt->m_Airline); |
| < | Data->Add( “Airline”, under); |

| | |
|---|---|
| < | } else { |

1257,1258d1238

| | |
|---|---|
| < | } |
| < | if (!flags->white_label) |

1262,1265d1241

| | |
|---|---|
| < | if (flags->hide_flight) { |

| | |
|---|---|
| < | sprintf(under “_%s”, flt->m_FlightNum); |
| < | Data->Add( “FlightNumber”, under); |

| | |
|---|---|
| < | } else { |

1267,1271d1242

| | |
|---|---|
| < | } |
| < | if(flags->hide_time & 2) { |

| | |
|---|---|
| < | sprintf(under “_%s”, flt->m_From); |
| < | Data->Add( “FromCity”, under); |

| | |
|---|---|
| < | } else { |

1273,1277d1243

| | |
|---|---|
| < | } |
| < | if(flags->hide_time & 1) { |

| | |
|---|---|
| < | sprintf(under, “_%s”, flt->m_To); |
| < | Data->Add( “ToCity”, under); |

| | |
|---|---|
| < | } else { |

1279,1289c1245,1246

| | |
|---|---|
| < | } |
| < | if (flags->hide_time) { |

| | |
|---|---|
| < | sprintf(under “_%d”flt->m_DepTimeDate); |
| < | Data->Add( “Fromdate”, under); |
| < | sprintf(under “_%d”, flt->m_ArrTimeDate); |
| < | Data->Add( “Todate”, under); |

| | |
|---|---|
| < | } else { |

| | |
|---|---|
| < | Data->Add( “Fromdate”, flt->m_DepTimeDate ); |
| < | Data->Add( “Todate”, flt->m_ArrTimeDate ); |

| | |
|---|---|
| < | } |
| < | |
| --- | |
| > | Data->Add( “FromDate”, flt->m_DepTimeDate_Asc ); |
| > | Data->Add( “ToDate”, flt->m_ArrTimeDate_Asc ); |

===========================================
=====================================
Archive file: /tlx003/home/users/cert/common/itinstr.cpp
retrieving revision 4.15
retrieving revision 4.11
diff -r4.15 -r4.11
24c24
< static char *rcsid = “$Header: /tlx003/home/users/cert/common/itinstr.cpp
4.15 1999/11/15 19:20:55 cmattair Exp $”;
---
> static char *rcsid = “$Header: /tlx003/home/users/cert/common/itinstr.cpp
4.11 1999/08/30 15:25:31 cmattair Exp $”;
32c32
< static rate_flags flags;
---
> static int white_label;
35d34
< static void AddCity (char *city );
43d41
< static void AddFlightNumber ( char *Field );
52,53d49
< static void GetFlightNumber (char *Field size_t field_size );
< static void GetCity( char *city );
103,107c99

| | |
|---|---|
| < | AddField( pd->Rate.flags.white_label ); |
| < | AddField( pd->Rate.flags.hide_flight ); |
| < | AddField( pd->Rate.flags.hide_time ); |
| < | flags = pd->Rate.flags; |
| < | AddField( pd->Rate.cc_authorization_reqd ); |
| --- | |
| > | AddField( white_label = pd->Rate.white_label); |

117,119d108

| | |
|---|---|
| < | AddField( pd->Rate.purchase_rule ); |
| < | AddField( pd->Rate.purchase_snippet ); |
| < | AddField( pd->Rate.purchase_requirements ); |

211,215c200,201

| | |
|---|---|
| < | GetField( pd->Rate.flags.white_label ); |
| < | GetField( pd->Rate.flags.hide_flight ); |
| < | GetField( pd->Rate.flags.hide_time ); |
| < | flags = pd->Rate.flags; |
| < | GetField( pd->Rate.cc_authorization_reqd ); |
| --- | |
| > | GetField( pd->Rate.white_label ); |
| > | white_label = pd->Rate.id; |

225,227d210

| | |
|---|---|
| < | GetField( pd->Rate.purchase_rule, sizeof(pd->Rate.purchase_rule) ); |
| < | GetField( pd->Rate .purchase_snippet, |

sizeof(pd->Rate.purchase_snippet));

| | |
|---|---|
| < | GetField( pd->Rate.purchase_requirements, |

sizeof(pd->Rate.purchase_requirements));
###############################################
#################################
#NOTE:
# the following code is changed from the as implemented version
# it implements the actual disguise mechanism, and if exposed,
# would allow users to determine the particulars of a white label
# flight. The sections altered have been replaced with <what is being done>.
###############################################
#################################
268,296d250
< // AddFlightNUmber(char *) - adds flight number to the encoded itinerary
string
< static void AddFlightNumber(char *flight)
<
< {

| | |
|---|---|
| < | char temp[16]; |
| < | RightTrim( flight ); |
| < | if (flags.hide_flight) { |

| | |
|---|---|
| < | sprintf(temp, “%d”, <disguise flight number>); |
| < | flight = temp; |

| | |
|---|---|
| < | } |
| < | strcat( Work, flight ); |
| < | strcat( Work, DELIMITER ); |

< }
<
<
< // AddCity(char *) - adds city to the encoded itinerary string
< static void AddCity(char *city)
<
< {

| | |
|---|---|
| < | char temp[16]; |
| < | RightTrim( city); |
| < | if (flags.hide_flight) { |

| | |
|---|---|
| < | sprintf(temp, “%d”, <disguise city code>); |
| < | city = temp; |

| | |
|---|---|
| < | } |
| < | strcat( Work, city ); |
| < | strcat( Work, DELIMITER ); |

< }
<
325,328c279

| | |
|---|---|
| < | char NumberStr[16]; |
| < | if (flags.hide_time) |

| | |
|---|---|
| < | sprintf( NumberStr, “%d”, <disguise flight time>); |

| | |
|---|---|
| < | else |
| --- | |
| > | char NumberStr[16] = “”; |

348c299

| | |
|---|---|
| < | AddField( (flags.white_label) ? EncodeConsolidator(Trip->OWCarrier) |
| --- | |
| > | AddField( (white_label) ? EncodeConsolidator(Trip->OWCarrier) |

364c315

| | |
|---|---|
| < | AddField( (flags.white_label) ? EncodeConsolidator(Flight->m_Airline) |
| --- | |
| > | AddField( (white_label) ? EncodeConsolidator(Flight->m_Airline) |

369c320

| | |
|---|---|
| < | AddFlightNumber( Flight.->m_FlightNum ); |
| --- | |
| > | AddField( Flight->m_FlightNum ); |

384,402d334
< // GetCity - gets a city from the encoded itinerary string
< static void GetCity( char *city)
< {

| | |
|---|---|
| < | static char xvert[] = “0123456789ABCDEFGHIJKLMNOPQRSTUVWXYZ”; |
| < | char temp[16]; |
| < | int int_temp; |
| < | GetField(temp, 16); |
| < | if (flags.hide_flight) { |

| | |
|---|---|
| < | <undisguise city code> |

| | |
|---|---|
| < | } |
| < | strcpy(city, temp); |

< }
444,445c376

| | |
|---|---|
| < | char NumberStr[16]; |
| < | time_t temp; |
| --- | |
| > | char NumberStr[16] = “”; |

447,451c378

| | |
|---|---|
| < | <undisguise time> |
| < | |
| < | return(temp); |
| --- | |
| > | return((time_t) atoi( NumberStr )); |

455,468d381
< //GetFlightNumber - gets a flight number from the encoded itinerary string
< static void GetFlightNumber(char *field, size_t field_size)
<
< }

| | |
|---|---|
| < | char temp[16]; |
| < | int flight_num; |
| < | GetField( temp, 16 ); |
| < | if (flags.hide_flight) |

| | |
|---|---|
| < | <undisguse flight number>; |

| | |
|---|---|
| < | temp[field_size = ‘\0’; |
| < | strcpy(field, temp); |

< }
<
<
###############################################
#################################
# END OF ALTERED SOURCE
###############################################
#################################
480c393

| | |
|---|---|
| < | strcpy(Trip->OWCarrier, (flags.white_label) |
| > | strcpy(Trip->OWCarrier, (white_label) |

503c416

| | |
|---|---|
| < | strcpy(Flight->m_Airline, (flags.white_label) |
| --- | |
| > | strcpy(Flight->m_Airline, (white_label) |

509c422

| | |
|---|---|
| < | GetFlightNumber( Flight->m_FlightNum, sizeof(Flight->m_FlightNum) |
| ); | |
| --- | |
| > | GetField( Flight->m_FlightNum, sizeof(Flight->m_FlightNum) ); |

===========================================
=====================================
Archive file: /tlx003/home/users/cert/include/air/cfare.h
retrieving revision 4.52
retrieving revision 4.47
diff -r4.52 -r4.47
1875,1898c1783,1796

| | |
|---|---|
| < | Fielder.GetField( 20, Rate.flags.white_label ); |
| < | Fielder.GetField( 21, Rate.flags.hide_flight ); |
| < | Fielder.GetField( 22, Rate.flags.hide_time ); |
| < | Fielder.GetField( 23, Rate.airline_code ); |
| < | if (Rate.flags.white_label) |

| | |
|---|---|
| < | strcpy(Rate.airline_code |

| | |
|---|---|
| < | DecodeConsolidator(Rate.airline_code)); |
| --- | |

| | |
|---|---|
| > | Fielder.GetField( 19, Rate.airline_code ); |

===========================================
=====================================
Archive file: /tlx003lhome/users/cert/include/common/common.h
retrieving revision 4.14
retrieving revision 4.10
diff -r4.14 -r4.10
22d21
< #include “packages/r_rate.h”
40d38
44,45c42,43
< void flight_to_collection( tCollection *Data, char *section, char *class_type,

| | |
|---|---|
| < | rate_flags *flags, CFlight *flt); |
| --- | |

> void flight_to_collection( tCollection *Data char *section

| | |
|---|---|
| > | char *class_type,CFlight *flt); |

===========================================
=====================================
Archive file: /tlx003/home/users/cert/include/itin//itinair.h
retrieving revision 4.5
retrieving revision 4.3
diff -r4.5 -r4.3
11d10
< #include “packages/r_rate.h”
20c19
< void AirCollection (sTrip *Air, rate_flags *flags, tCollection *Data );
---
> void AirCollection (sTrip *Air, tCollection *Data );
===========================================
=====================================
Archive file: /tlx003/home/users/cert/include/packages/r_rate.h
retrieving revision 4.9
retrieving revision 4.4
diff -r4.9 -r4.4
8,13d7

| | |
|---|---|
| < | int white_label, |

| | |
|---|---|
| < | hide_flight, |
| < | hide_time; |

< } rate_flags;
<
< typedef struct {
32d24

| | |
|---|---|
| < | rate_flags flags; |

===========================================
=====================================
Archive file: /tlx003/home/users/cert/itin/itin.cpp
retrieving revision 4.13
retrieving revision 4.10
diff -r4.13 -r4.10
474c472

| | |
|---|---|
| < | AirCollection( &Itin->Seg[i].Air, &Itin->Rate.flags, Data ); |
| > | AirCollection( &Itin->Seg[i].Air, Data ); |

===========================================
=====================================
Archive file: /tlx003/home/users/cert/itin/itinair.cpp
retrieving revision 4.13
retrieving revision 4.10
diff -r4.13 -r4.10
14d13
< #include “packages/r_rate.h”
17c16
< static char *rcsid = “$Header: /tlx003/home/users/cert/itin/itinair.cpp 4.13
1999/11/08 17:16:17 cmattair Exp $”;
---
> static char *rcsid = “$Header: /tlx003/home/users/cert/itin/itinair.cpp 4.10
1999/08/12 20:14:43 cmattair Exp $”;
20,21d18
< static rate_flags flags;
<
124c121
< void AirCollection( CTrip *Air, rate_flags *flags_in, tCollection *Data )
---
> void AirCollection( CTrip *Air, tCollection *Data )
126,127c123

| | |
|---|---|
| < | int j = 0, |

| | |
|---|---|
| < | flights_minus_2 |
| --- | |

| | |
|---|---|
| > | int j = 0; |

135,136d130

| | |
|---|---|
| < | flags = *flags_in; |
| < | |

150,151d143

| | |
|---|---|
| < | if (flags.hide_time && (flights_minus_2 = Air->m_NumFlights - 2) < 0) |

| | |
|---|---|
| < | flags.hide_time = 4; |

154,158c146

| | |
|---|---|
| < | flight_to_collection(Data, “Segment/Flight”, Data->Find( “ClassType” ), |

| | |
|---|---|
| < | &flags, flt); |

| | |
|---|---|
| < | if (flags.hide_time & 3) |

| | |
|---|---|
| < | flags.hide_time = (j != flights_minus_2) ? 3 : 2; |
| < | |
| --- | |

| | |
|---|---|
| > | flight_to_collection(Data, “Segment/Flight”, Data->Find( “ClassType” ), |

flt);
===========================================
=====================================
Archive file: /tlx003/home/users/cert/itin/itinmain.cpp
retrieving revision 4.13
retrieving revision 4.10
diff -r4.13 -r4.10
501c498

| | |
|---|---|
| < | AirCollection( &Itin.Seg[Segment].Air, &Itin.Rate.flags, Data ); |
| --- | |
| > | AirCollection( &Itin.Seg[Segment].Air, Data ); |

===========================================
=====================================
Archive file: /tlx003/home/users/cert/languages/ae/mail/bkfail.ml
retrieving revision 4.5
retrieving revision 4.3
diff -r4.5 -r4.3

| | |
|---|---|
| < | $@just_date(${FromDate}) - *$@cons_name(${Airline}) Flight |

$@flight_number(${FlightNumber})$@lf( )
---

| | |
|---|---|
| > | $@just_date(${FromDate}) - *$@Airline_name(${Airline}) Flight |

${FlightNumber}$@lf( )
32c32

| | |
|---|---|
| < | $@just_date(${FromDate}) - $@cons_name(${Airline}) Flight |

$@flight_number(${FlightNumher})$@lf( )
---

| | |
|---|---|
| > | $@just_date(${FromDate}) - $@Airline_name(${Airline}) Flight |

${FlightNumber}$@lf( )
34c34

| | |
|---|---|
| < | Leave: $@us_time(${FromDate}) $@City_name(${FromCity}) |

$@city_code(${FromCity})$@lf( )
---

| | |
|---|---|
| > | Leave: $@us_time(${FromDate}) $@City_name(${FromCity}) |

(${FromCity})
36c36

| | |
|---|---|
| < | Arrive: $@us_time(${ToDate}) $@City_name(${ToCity}) |

$@city_code(${ToCity})$@lf( )
---

| | |
|---|---|
| > | Arrive: $@us_time(${ToDate}) $@City_name(${ToCity}) |

(${ToCity})
===========================================
=====================================
Archive file: /tlx003/home/users/cert/languages/ae/mail/bkokay.ml
retrieving revision 4.25
retrieving revision 4.17
diff -r4.25 -r4.17
22d21

| | |
|---|---|
| < | $$SET USECONS = 1 |

< $$if${USECONS}
110c107

| | |
|---|---|
| < | $@just_date(${FromDate}) - *$@Cons_name($ {Airline}) Flight |

$@flight_number(${FlightNumber})$@lf( )
---

| | |
|---|---|
| > | $@just_date(${FromDate}) - *$@Arline_name(${Airline}) Flight |

${FlightNumber}$@lf( )
112c109

| | |
|---|---|
| < | $@just_date(${FromDate}) - $@Cons_name(${Airline}) Flight |

$@flight_number(${FlightNumber})$@lf( )
---

| | |
|---|---|
| > | $@just_date(${FromDate}) - $@Airline_name(${Airline}) Flight |

${FlightNumber}$@lf( )
114,121c111
< $$else

| | |
|---|---|
| < | $$if${operator} |

| | |
|---|---|
| < | $@just_date(${FromDate}) - *$@Arline_name(${Airline}) Flight |

$@flight_number(${FlightNumber})$@lf( )

| | |
|---|---|
| < | $$else |

| | |
|---|---|
| < | $@just_date(${FromDate}) - $@Airline_name(${Airline}) Flight |

$@flight_number(${FlightNumber})$@lf( )

| | |
|---|---|
| < | $$endif |

< $$endif

| | |
|---|---|
| < | Leave: $@us_time(${FromDate}) $@City_name(${FromCity}) |

$@city_code(${FromCity})$@lf( )
---

| | |
|---|---|
| > | Leave: $@us_time($ {FromDate}) $@City_name(${FromCity}) |

(${FromCity})$@lf( )
123c113

| | |
|---|---|
| < | Arrive: $@us_time(${ToDate}) $@City_name(${ToCity}) |

$@city_code(${ToCity})$@lf( )
---

| | |
|---|---|
| > | Arrive: $@us_time(${ToDate}) $@City_name(${ToCity}) |

(${ToCity})$@lf( )
126c116

| | |
|---|---|
| < | Arrive: $@date_paren(${ToDate}) $@City_name(${ToCity}) |

$@city_code(${ToCity})$@lf( )
---

| | |
|---|---|
| > | Arrive: $@date(${ToDate}) $@City_name($ {ToCity}) |

(${ToCity})$@lf( )
===========================================
=====================================
Archive file: /tlx003/home/users/cert/languages/ae/support/airavailh.htm
retrieving revision 4.15
retrieving revision 4.14
diff -r4.15 -r4.14
53,56d52
< TIP: To ensure that the lowest available price is found, pick the SAME
AIRLINE on all ffights
< when available. <BR>
< <BR>
<
===========================================
=====================================
<!-- help text Copyright 1999, 1travel.inc, All rights reserved -->
$$SET page_id=4965
$$SET PageTitle=Unnamed Airlines
$$include stdhead0.htm
<TABLE BORDER=0 WIDTH=575 CELLPADDING=2>
<TR>
<TD NOWRAP WIDTH=15 VALIGN=“top”>
&nbsp;
</TD>
<TD WIDTH=5>
&nbsp;
</TD>
<TD>

In some cases, the deeply-discounted fares we have negotiated with an airline are so low that we have agreed to conceal the airline name until after you purchase the ticket. You will still be able to create your itinerary, and you will know the schedule for your travel before you purchase your ticket. Once you have purchased your ticket, Farebeater reveals the airline in the final itinerary that appears after your reservation has been processed. The confirming email you receive will also contain the airline name.<BR>

<BR>

Remember, these special low rates are NONREFUNDABLE, NONTRANSFERABLE AND NON-CHANGEABLE. <I> If you are in any way uncomfortable with the idea that

the actual airline name will only be revealed after you have purchased your tickets, select a different flight. </I> However, if you are interested in substantial airfare savings, you should definitely consider these incredible money-saving fares. <BR>

<BR>
<A
HREF=“http://${SERVER_NAME}/${language}/cgi-programs/hpage.cgi?${coo
kie}+ht_/${language}/${sitecountry}/support/${HelpPage?index.html}”>Help
Index </A>

</TD >

</TR>
</TABLE>
$$include stdfoot0.htm
===========================================
=====================================
Archive file: /tlx003/home/users/cert/languages/ae/support/ccconfitinh.htm
retrieving revision 4.13
retrieving revision 4.10
diff -r4.13 -r4.10
166,168d165
< (In certain cases, <A
HREF=“http://${SERVER_NAME}/${language}/cgi-programs/hpage.cgi?${coo
kie}+ht_/${language}/${sitecountry}/support/airhideh.htm”>airline
names</A>, <A
HREF=“http://${SERVER_NAME}/${language}/cgi-programs/hpage.cgi?${coo
kie}+ht_/${language}/${sitecountry}/support/airnumhideh.htm”>flight
numbers</A>, and/or <A
HREF=“http://$(SERVER_NAME}/${language}/cgi-programs/hpage.cgi?${coo
kie}+ht_/${language}/${sitecountry}/support/airschedhideh.htm”>flight times
and connecting city information </a> may be
< hidden until you have purchased your tickets.) <BR>
< <BR>
===========================================
=====================================
Archive file: /tlx003/home/users/cert/languages/ae/support/confitinh.htm
retrieving revision 4.19
retrieving revision 4.16
diff -r4.19 -r4.16
139,141d138
< (In certain cases, <A
HREF=“http://${SERVER_NAME}/${language}/cgi-programs/hpage.cgi?${coo
kie}+ht_/${language}/${sitecountry}/support/airhideh.htm”>airline
names</A>, <A
HREF=“http://$(SERVER_NAME}/${language}/cgi-programs/hpage.cgi?${coo
kie}+ht_/${language}/$(sitecountry}/support/airnumhideh.htm”>flight
numbers</A>, and/or <A
HREF=“http://${SERVER_NAME }/${language}/cgi-programs/hpage.cgi?${coo
kie}+ht_/${language}/${sitecountry}/support/airschedhideh.htm”>flight times
and connecting city information </a> may be
< hidden until you have purchased your tickets.) <BR>
< <BR>
===========================================
=====================================
Archive file: /tlx003/home/users/cert/languages/ae/support/curritinh.htm
retrieving revision 4.7
retrieving revision 4.4
diff -r4.7 -r4.4
1c1
< <!-- help text Copyright 1999, 1travel.inc, All rights reserved -->
---
> <!-- help text Copyright 1998, Travelogix, Inc.-->
28,34d27
<
< $$IF ${CONSOLIDATOR_ENABLED} == 1
< (Note that in certain cases, <A
HREF=“http://$(SERVER_NAME}/$(language}/cgi-programs/hpage.cgi?${coo
kie}+ht_/$(language}/${sitecountry}/support/airhideh.htm”>airline
names</A>, <A
HREF=“http://${SERVER_NAME }/${language}/cgi-programs/hpage.cgi?${coo
kie}+ht_/${language}/${sitecountry}/support/airnumhideh.htm”>flight
numbers</A>, and/or <A
HREF=“http://$(SERVER_NAME}/${language}/cgi-programs/hpage.cgi?${coo
kie}+ht_/${language}/${sitecountry}/support/airschedhideh.htm”>flight times
and connecting city information </a> may be
< hidden until you have purchased your tickets.) <BR>
< <BR>
< $$ENDIF
<
===========================================
=====================================
Archive file: /tlx003/home/users/cert/languages/ae/support/dnfairavailh.htm
retrieving revision 4.13
retrieving revision 4.11
diff -r4.13 -r4.11
56,57c56
< <A
HREF=“http://$(SERVER_NANE}/${language}/cgi-programs/hpage.cgi?${coo
kie}+ht_/${language}/${sitecountry}/support/dnfrulesh.htm”>restrictions </A
>. In certain cases, <A
HREF=“http://$(SERVER_NAME}/${language}/cgi-programs/hpage.cgi?${coo
kie}+ht_/${language}/${sitecountry}/support/airhideh.htm”>airline
names</A>, <A
HREF=“http://$(SERVER_NAME}/${language}/cgi-programs/hpage.cgi?${coo
kie}+ht_/${language}/${sitecountry}/support/airnumhideh.htm”>flight
numbers</A>, and/or <A
HREF=“http://${SERVER_NAME}/${language}/cgi-programs/hpage.cgi?${coo
kie}+ht_/${language}/${sitecountry}/support/airschedhideh.htm”>flight times
and connecting city information </a> may be
< hidden until you have purchased your tickets.) <BR>
> <A
HREF=“http://${SERVER_NAME}/${language}/cgi-programs/hpage.cgi?${coo
kie}+ht_/${language}/${sitecountry}/support/dnfrulesh.htm”>restrictions </A
>.)<BR>
===========================================
=====================================
Archive file: /tlx003/home/users/cert/languages/ae/support/dnfairpriceh.htm
retrieving revision 4.14
retrieving revision 4.12
diff -r4.14 -r4.12
39,41d38
< In certain cases, <A
HREF=“http://${SERVER_NAME}/${language}/cgi-programs/hpage.cgi?${coo
kie}+ht_/${language}/${sitecountry}/support/airhideh.htm”>airline
names</A>, <A
HREF=“http://${SERVER_NAME}/${language}/cgi-programs/hpage.cgi?${coo
kie}+ht_/${language}/${sitecountry}/support/airnumhideh.htm”>flight
numbers</A>, and/or <A
HREF=“http://${SERVER_NAME}/${language}/cgi-programs/hpage.cgi?${coo
kie}+ht_/${language}/${sitecountry}/support/airschedhideh.htm”>flight times
and connecting city information </a> may be
< hidden until you have purchased your tickets. <BR>
< <BR>
===========================================
=====================================
Archive file: /tlx003/home/users/cert/languages/ae/support/faqh.htm
retrieving revision 4.8
retrieving revision 4.6
diff -r4.8 -r4.6
123,124c123,124
< How come sometimes the name of the airline/flight time/flight number is not
displayed?<BR></B>

<In some cases, the deeply-discounted fares we have negotiated with an airline are so low that we have agreed to conceal this information until after you purchase the ticket. You will still be able to create your itinerary, and you will know the schedule for your travel before you purchase your ticket. Once you have purchased your ticket, Farebeater reveals the information in the final itinerary that appears after your reservation has been processed. The confirming email you receive will also contain the airline name. <BR>

>How come sometimes the name of the airline is not displayed?<BR></B>

>In some cases, the deeply-discounted fares we have negotiated with an airline are so low that we have agreed to conceal the airline name until after you purchase the ticket. You will still be able to create your itinerary, and you will know the schedule for your travel before you purchase your ticket. Once you have purchased your ticket, Farebeater reveals the airline in the final itinerary that appears after your reservation has been processed. The confirming email you receive will also contain the airline name.<BR>

126c126

<Remember, these special low rates are NONREFUNDABLE, NONTRANSFERABLE AND NON-CHANGEABLE. <I> If you are in any way uncomfortable with the idea that this information will only be revealed after you have purchased your tickets, select a different flight. </I> However, if you are interested in substantial airfare savings, you should definitely consider these incredible money-saving fares.<BR>

>Remember, these special low rates are NONREFUNDABLE, NONTRANSFERABLE AND NON-CHANGEABLE. <I> If you are in any way uncomfortable with the idea that the actual airline name will only be revealed after you have purchased your tickets, please select a different flight. </I> However, if you are more interested in substantial airfare savings, you should definitely consider these special money-saving fares.<BR>

Archive file:/tlx003/home/users/cert/languages/ae/support/farebeath.htm

retrieving revision 4.9

retrieving revision 4.7

diff-r4.9-r4.7

69,70c69

<<A

HREF=“http://${SERVER_NAME}/${language}/cgi-programs/hpage.cgi?${cookie}+ht_/${language}/${sitecountry}/support/dnfrulesh.htm”>restrictions</A>, and availability of Discount Negotiated Fares is not guaranteed until time of booking. In certain cases, <A

HREF=“http://${SERVER_NAME}/${language}/cgi-programs/hpage.cgi?${cookie}+ht_/${language}/${sitecountry}/support/airhideh.htm”>airline names</A>, <A

HREF=“http://${SERVER_NAME}/${language}/cgi-programs/hpage.cgi?${cookie}+ht_/${language}/${sitecountry}/support/airnumhideh.htm”>flight numbers</A>, and/or <A

HREF=“http://${SERVER_NAME}/${language}/cgi-programs/hpage.cgi?${cookie}+ht_/${language}/${sitecountry}/support/airschedhideh.htm”>flight times and connecting city information</a> may be

<hidden until you have purchased your tickets.)<BR>

><A

HREF=“http://${SERVER_NAME}/${language}/cgi-programs/hpage.cgi?${cookie}+ht_/${language}/${sitecountry}/support/dnfrulesh.htm”>restrictions</A>, and availability of Discount Negotiated Fares is not guaranteed until time of booking.)<BR>

Archive file:/tlx003/home/users/cert/languages/ae/support/support.htm

retrieving revision 4.8

retrieving revision 4.6

diff-r4.8-r4.6

74,76d73

<<ul><font size=“−1”><a

href=“http://${SERVER_NAME}/${language}/cgi-programs/hpage.cgi?${cookie}+ht_/${language}/${sitecountry}/support/airhideh.htm”>Unnamed Airlines</a></font></ul>

<<ul><font size=“−1”><a

href=“http://${SERVER_NAME}/${language}/cgi-programs/hpage.cgi?${cookie}+ht_/${language}/${sitecountry}/support/airschedhideh.htm”>Hidden Flight Schedules</a></font></ul>

<<ul><font size=“−1”><a

href=“http://${SERVER_NAME}/${language}/cgi-programs/hpage.cgi?${cookie}+ht_/${language}/${sitecountry}/support/airnumhideh.htm”>Hidden Flight Numbers</a></font></ul>

87,89d83

<<ul><font size=“−1”><a

href=“http://${SERVER_NAME}/${language}/cgi-programs/hpage.cgi?${cookie}+ht_/${language}/${sitecountry}/support/airhideh.htm”>Unnamed Airlines</a></font></ul>

<<ul><font size=“−1”><a

href=“http://${SERVER_NAME}/${language}/cgi-programs/hpage.cgi?${cookie}+ht_/${language}/${sitecountry}/support/airschedhideh.htm”>Hidden Flight Schedules</a></font></ul>

<<ul><font size=“−1”><a

href=“http://${SERVER_NAME}/${language}/cgi-programs/hpage.cgi?${cookie}+ht_/${language}/${sitecountry}/support/airnumhideh.htm”>Hidden Flight Numbers</a></font></ul>

Archive file:/tlx003/home/users/cert/languages/ae/templates/cf.htm

retrieving revision 4.19

retrieving revision 4.16

diff −r4.19−r4.16

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

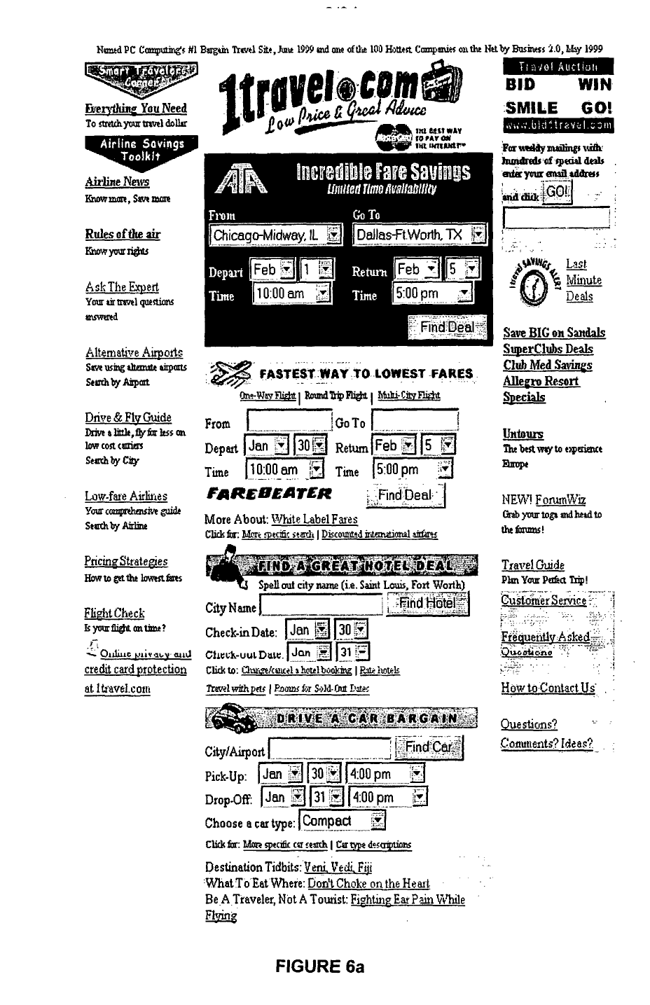

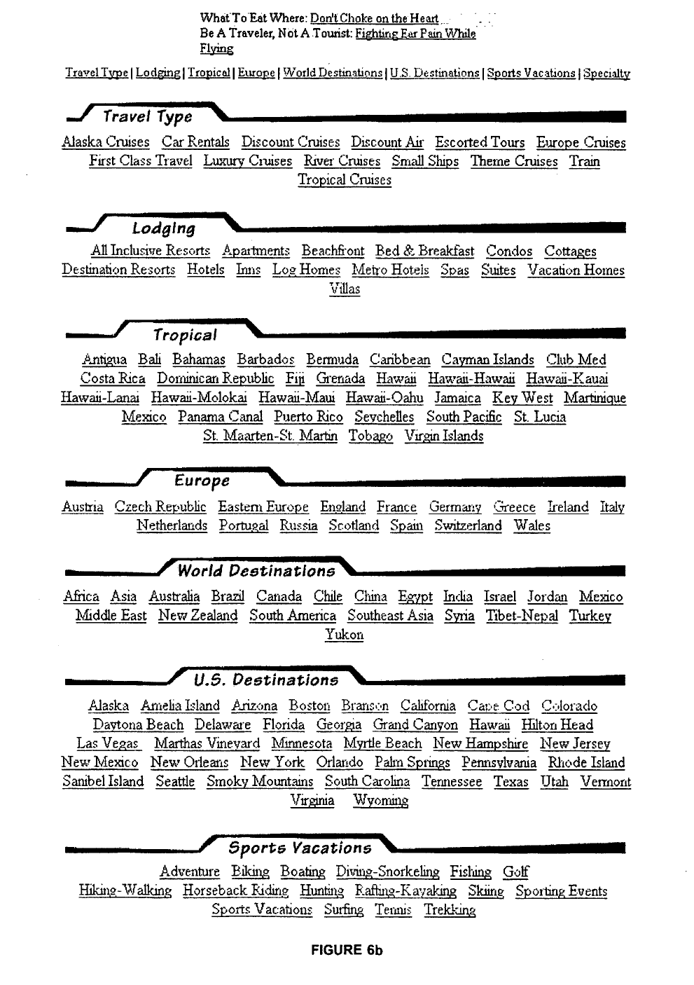

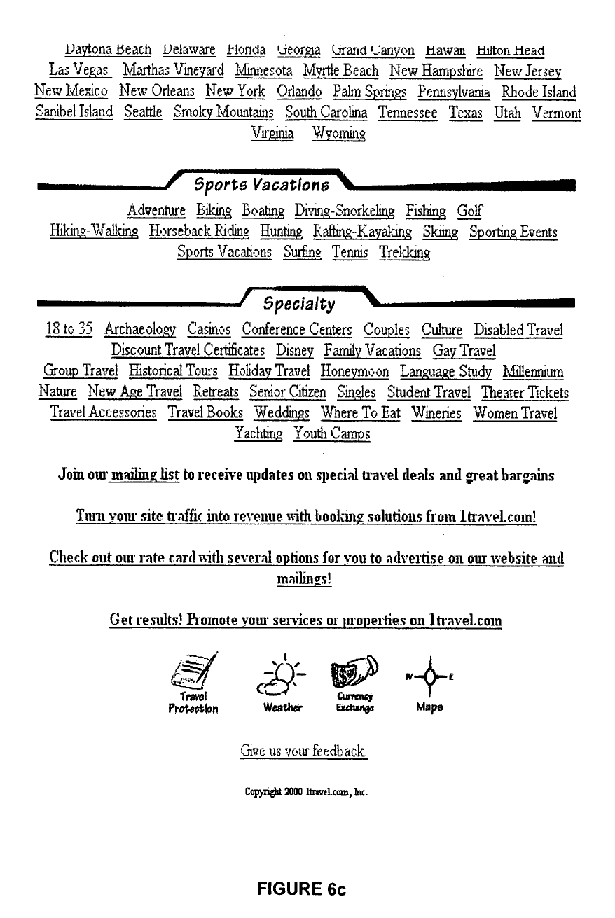

In a preferred embodiment, the system 100 and method 200 are implemented using the website http://onetravel.com. Exemplary screen displays encountered by a typical user of the website are illustrated in FIGS. 6a, 6b, 6c, 7, 8, 9a, 9b, 10a, 10b, 11, 12a, 12b, 12c, 12d, 13a and 13b.

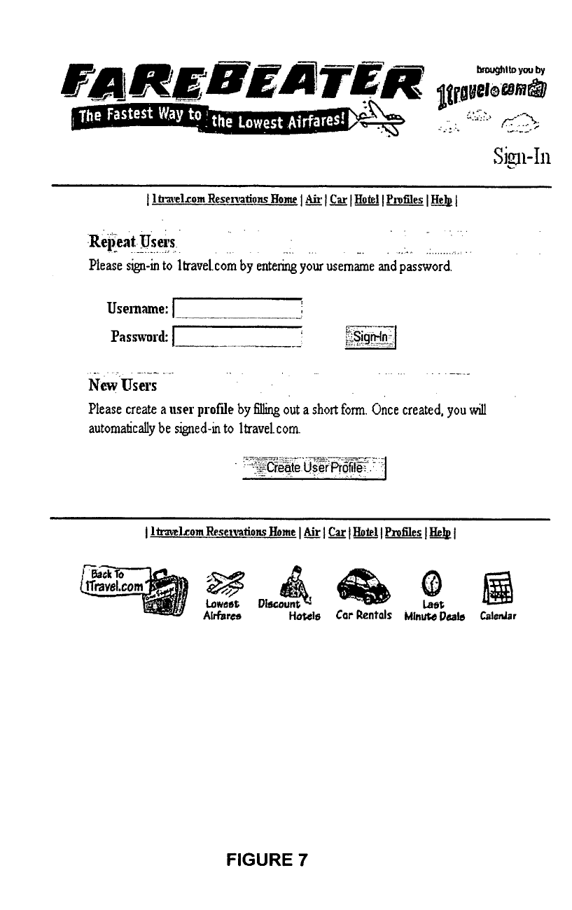

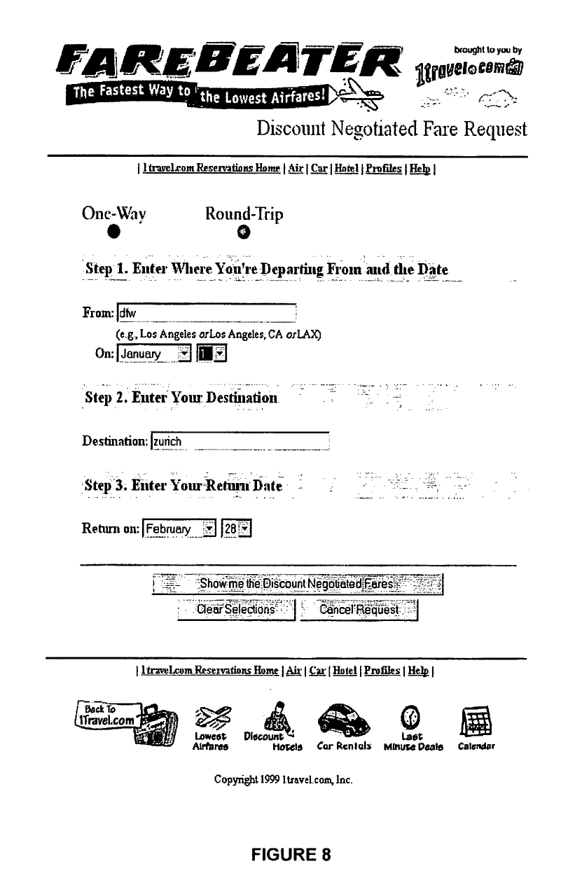

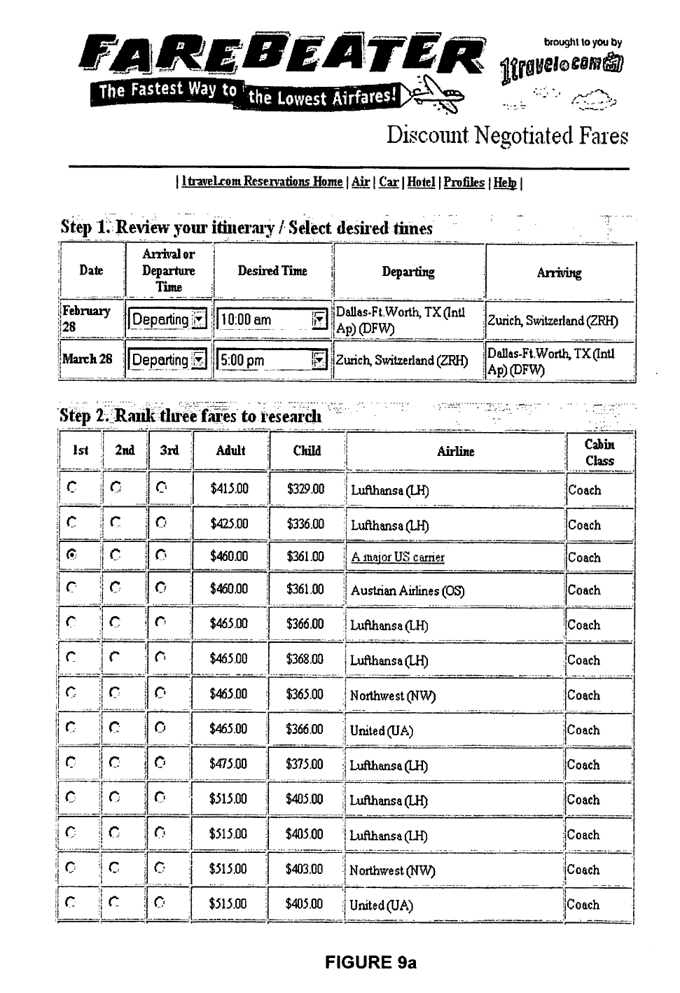

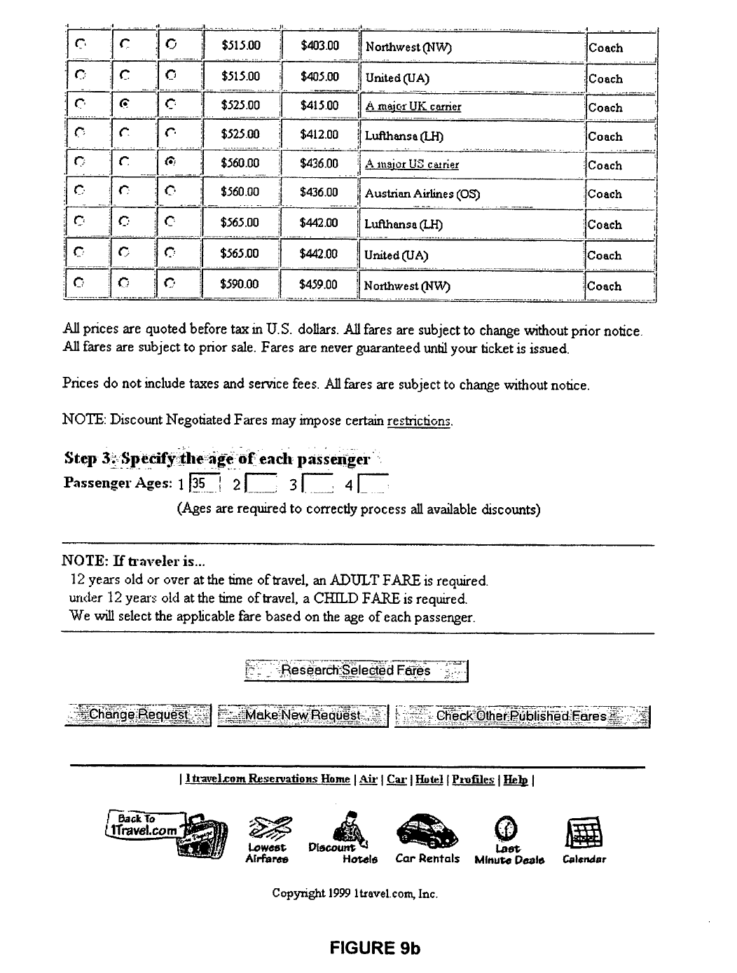

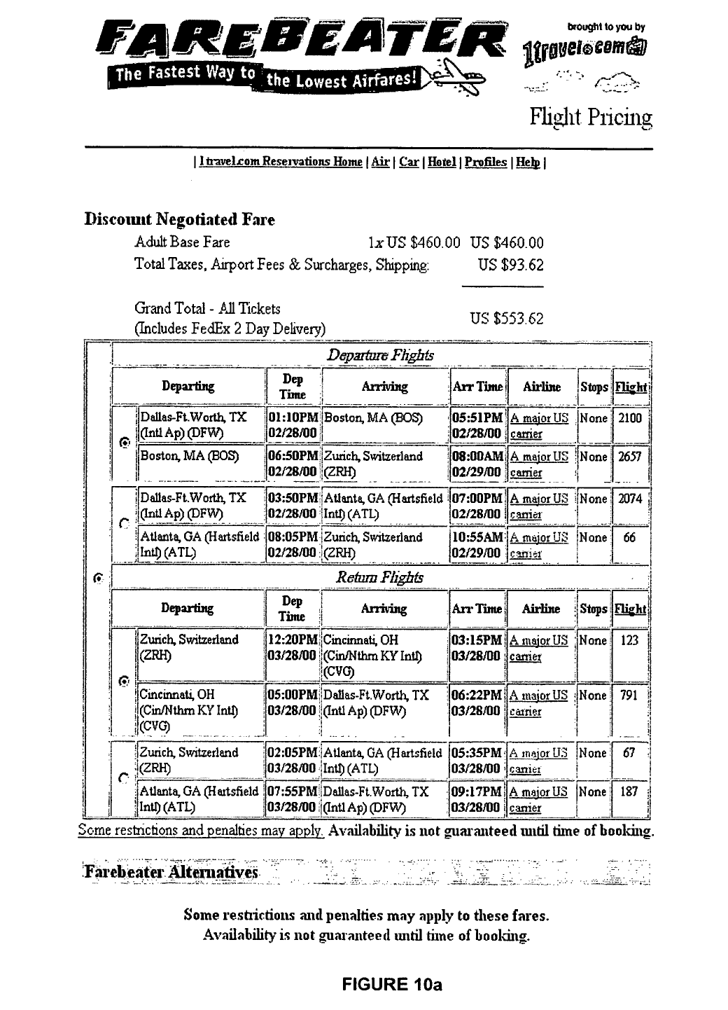

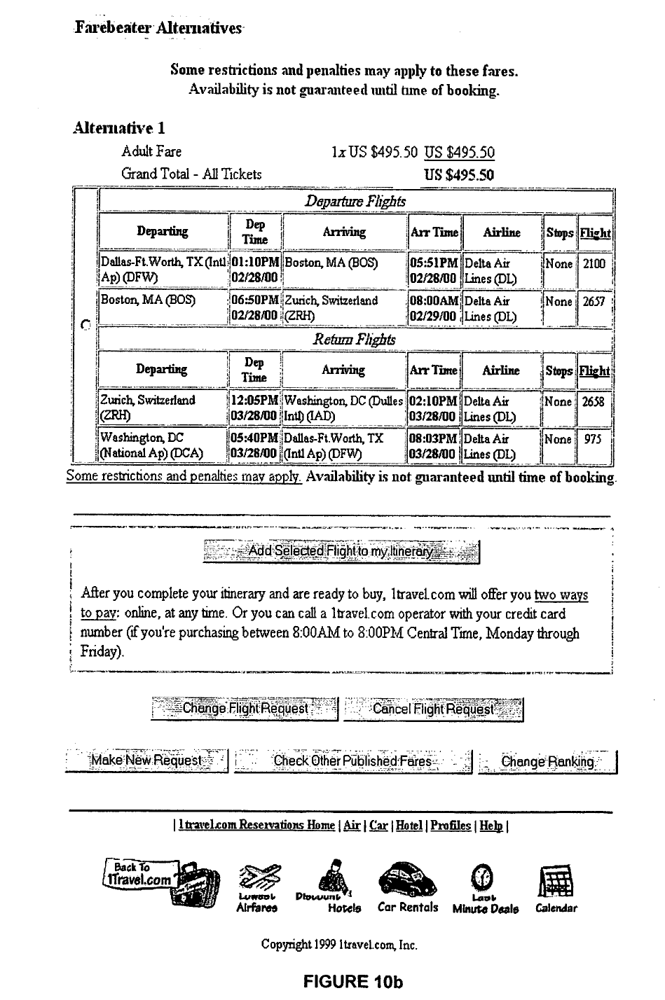

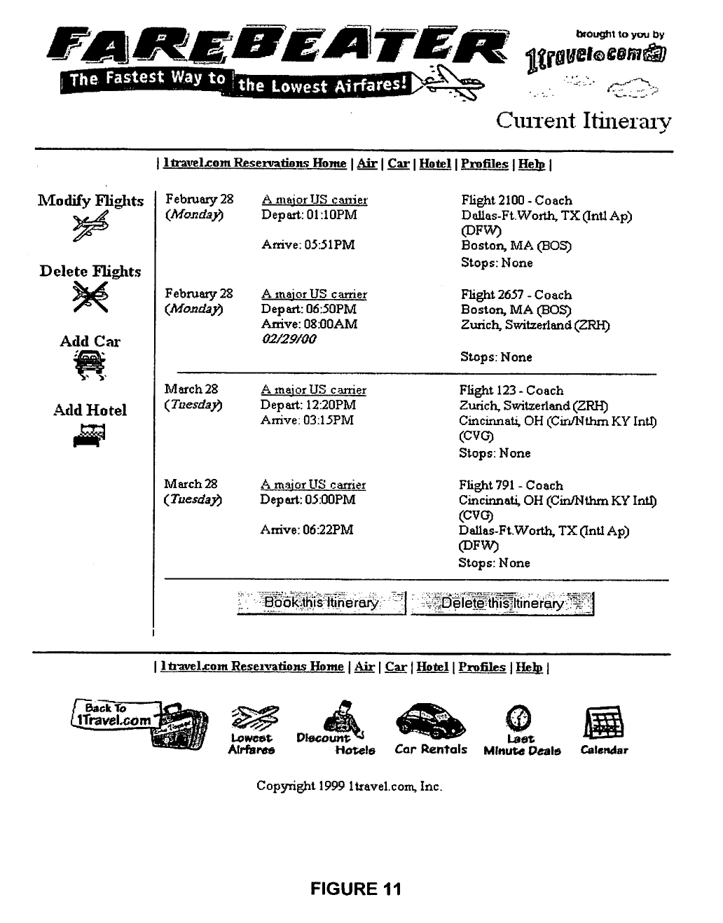

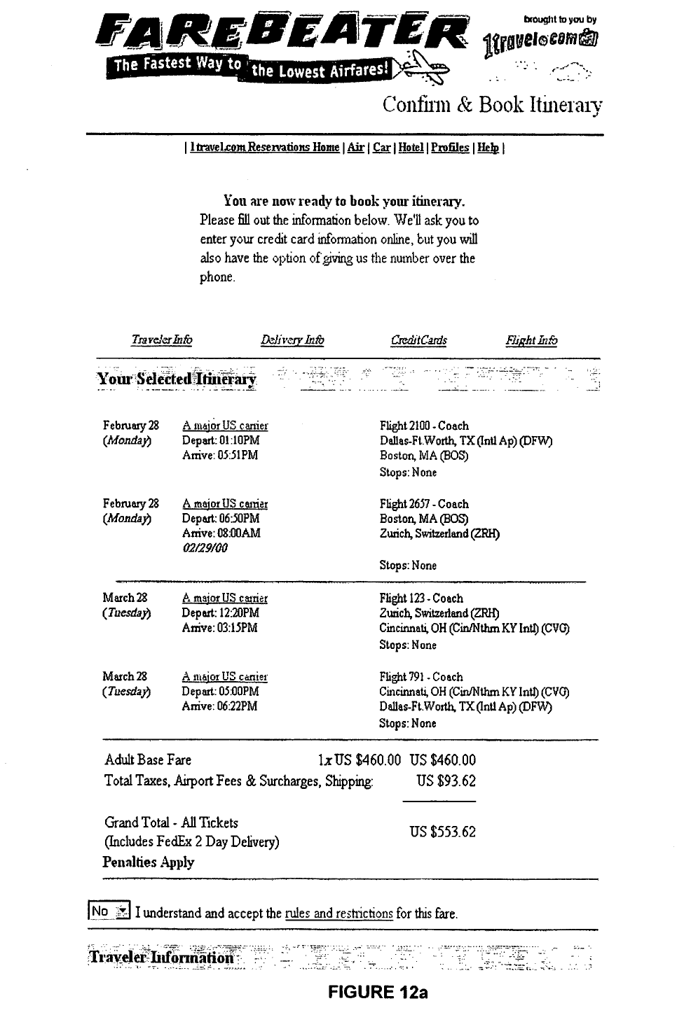

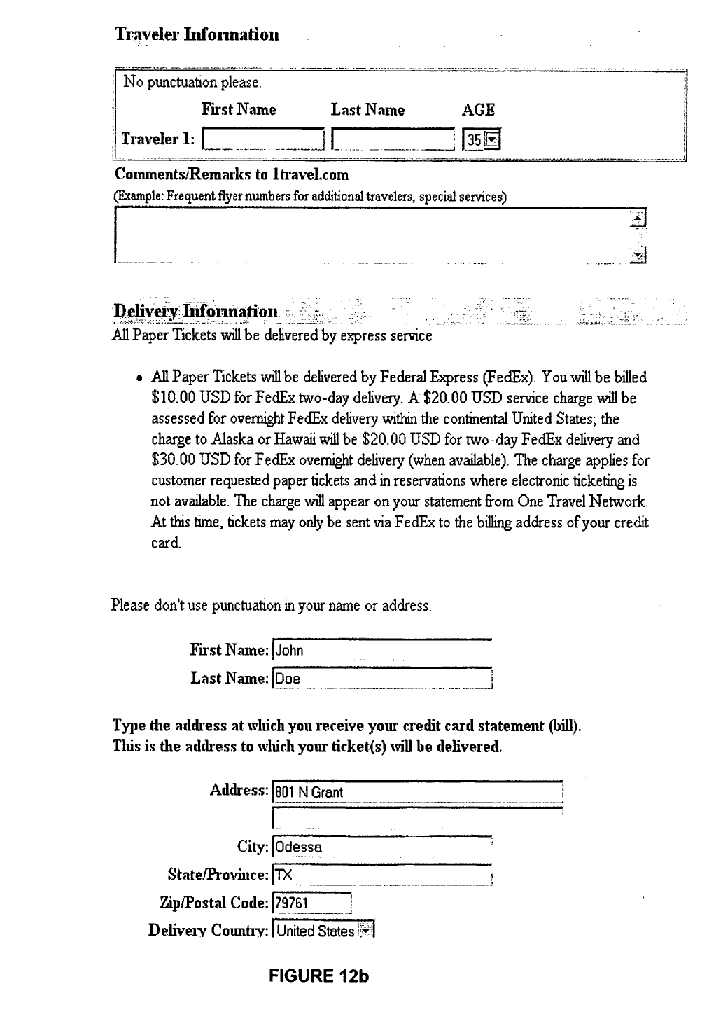

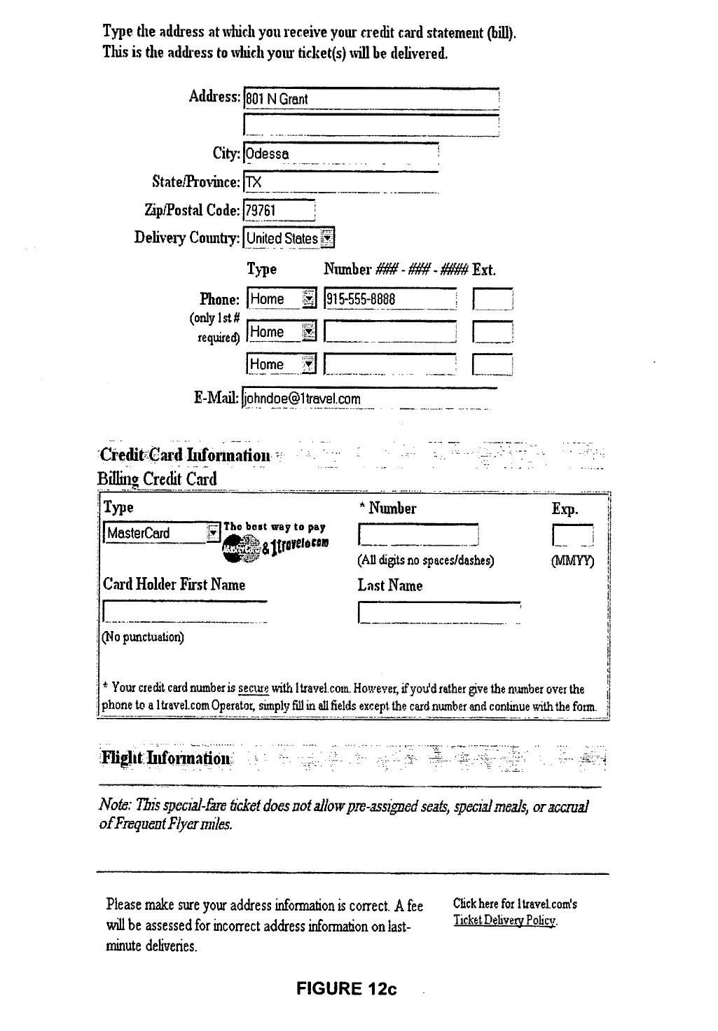

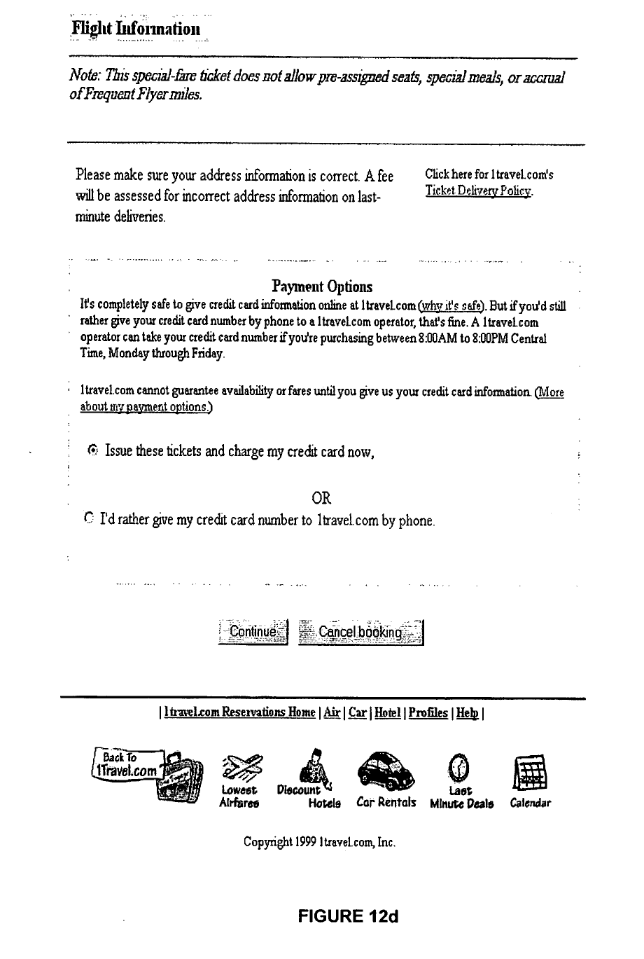

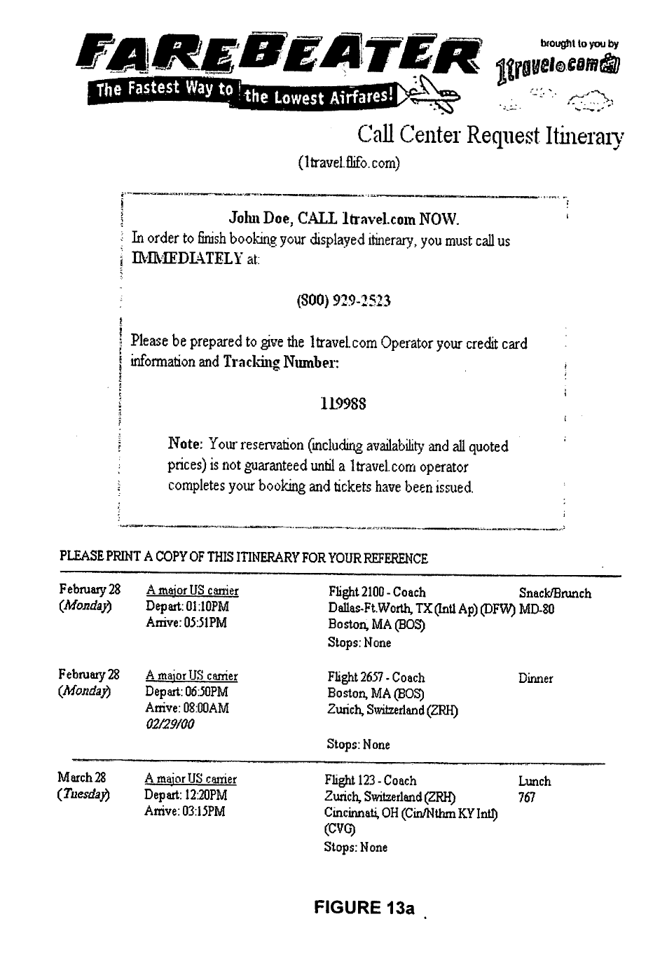

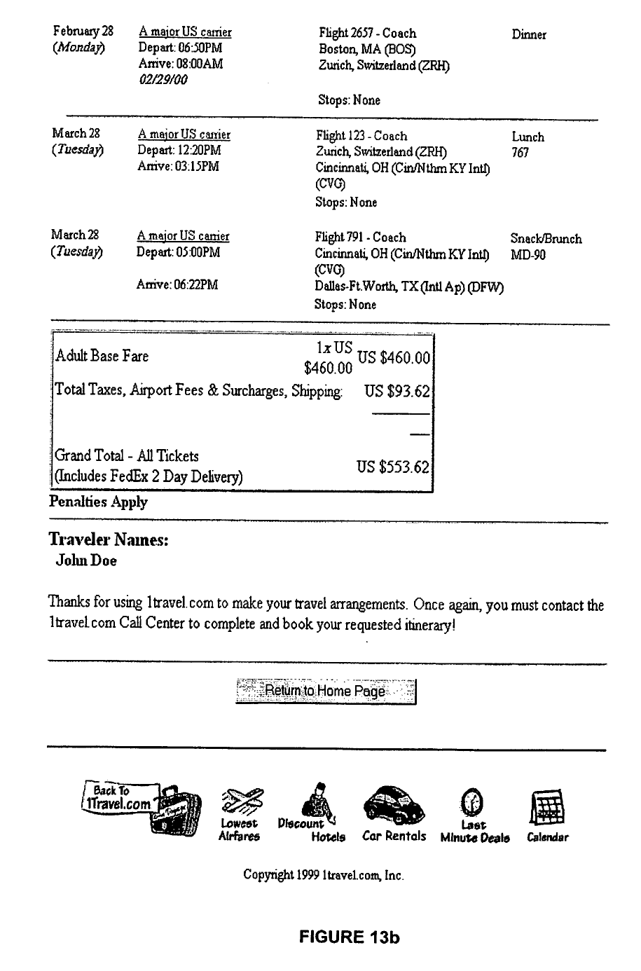

As illustrated in FIGS. 6a-6c, in an exemplary embodiment, a user may access a website that permits a user to purchase partially anonymous products such as, for example, airline tickets. As illustrated in FIG. 7, the user may then elect to login to the website using a user name and password. As illustrated in FIG. 8, after the user has logged in, the user may then enter an itinerary and then request the website to show the user the discount negotiated fares for the intineary. As illustrated in FIGS. 9a and 9b, after the user has requested the website to display the discount negotiated fares for the itinerary, the user may request the website to research selected fares. As illustrated in FIGS. 10a and 10b, after the user has requested the website to research selected fares, the user may select the selected fare or an alternative fare for adding to the user's selected itinerary. As illustrated in FIG. 11, after the website has selected a selected fare for addition to the user's current itinerary, the user may then book the current itinerary. As illustrated in FIGS. 12a, 12b, 12c and 12d, after the user has selected the current itinerary for booking, the user may then purchase the selected itinerary using the website. As illustrated in FIGS. 13a and 13b, in an alternative exemplary embodiment, after the user has selected the current itinerary for booking, the user may then purchase the selected itinerary by calling a call center.

As will be recognized by persons of ordinary skill in the art having the benefit of the present disclosure, multiple variations and modifications can be made in the embodiments of the invention. Although certain illustrative embodiments of the invention have been shown and described, a wide range of modifications, changes, and substitutions is contemplated in the foregoing disclosure. In some instances, some features of the present invention may be employed without a corresponding use of the other features. Accordingly, it is appropriate that the foregoing description be construed broadly and understood as being given by way of illustration and example only, the spirit and scope of the invention being limited only by the appended claims.

What is claimed is:

1. A computer implemented method of purchasing airline tickets, comprising:
entering one or more desired airline travel criteria;
retrieving and displaying one or more available airline travel resources that approximately match the desired airline travel criteria, wherein at least a portion of the full identity of the airline travel resources are withheld;
purchasing one or more of the available airline travel resources; and
displaying the withheld portion of the full identity of the purchased airline travel resource.

2. The method of claim 1, wherein the airline travel criteria include a permissible variation in a desired travel date.

3. The method of claim 1, wherein the withheld portion of the full identity of the purchased airline travel resource is selected from the group consisting of the identity of the airline, the stopover airports, the departure times, the arrival times, and the flight number.

4. The method of claim 1, wherein the displayed available airline travel resources include a time period for departure and arrival.

5. The method of claim 4, wherein the time period for departure and arrival is selected from the group consisting of morning, afternoon, evening, and overnight.

6. A computer program stored in a medium in machine readable format for a computer implemented method of purchasing airline tickets, comprising:
entering one or more desired airline travel criteria;
retrieving and displaying one or more available airline travel resources that approximately match the desired airline travel criteria, wherein at least a portion of the full identity of the airline travel resources are withheld;
purchasing one or more of the available airline travel resources; and
displaying the withheld portion of the full identity of the purchased airline travel resource.

7. The computer program of claim 6, wherein the airline travel criteria include a permissible variation in a desired travel date.

8. The computer program of claim 6, wherein the withheld portion of the full identity of the purchased airline travel resource is selected from the group consisting of the identity of the airline, the stopover airports, the departure times, the arrival times, and the flight number.

9. The computer program of claim 6, wherein the displayed available airline travel resources include a time period for departure and arrival.

10. The computer program of claim 9, wherein the time period for departure and arrival is selected from the group consisting of morning, afternoon, evening, and overnight.

11. A system for purchasing airline tickets, comprising:
a network;
one or more users coupled to the network; and
a host coupled to the users using the network adapted to:
permit the users to enter one or more desired airline travel criteria;
retrieve and display one or more available airline travel resources that approximately match the desired airline travel criteria, wherein at least a portion of the full identity of the airline travel resources are withheld;
permit the users to purchase one or more of the available airline travel resources; and
display the withheld portion of the full identity of the purchased airline travel resource after the purchase.

12. The system of claim 11, wherein the airline travel criteria include a permissible variation in a desired travel date.

13. The system of claim 11, wherein the withheld portion of the full identity of the purchased airline travel resource is selected from the group consisting of the identity of the airline, the stopover airports, the departure times, the arrival times, and the flight number.

14. The system of claim 11, wherein the displayed available airline travel resources include a time period for departure and arrival.

15. The system of claim 14, wherein the time period for departure and arrival is selected from the group consisting of morning, afternoon, evening, and overnight.

16. A computer implemented method of purchasing airline tickets, comprising:
withholding at least a portion of the full identity of the airline ticket until after the purchase of the airline ticket.

17. A computer implemented method of purchasing airline tickets, comprising:
generalizing at least a portion of the full identity of the airline ticket until after the purchase of the airline ticket.

18. A computer program stored in a medium in a machine-readable format, comprising a computer implemented method of purchasing airline tickets, including:
withholding at least a portion of the full identity of the airline ticket until after the purchase of the airline ticket.

19. A computer program stored in a medium in a machine-readable format, comprising a computer implemented method of purchasing airline tickets, including:
generalizing at least a portion of the full identity of the airline ticket until after the purchase of the airline ticket.

20. A system for purchasing airline tickets, comprising:
a network;
one or more users coupled to the network; and
a host coupled to the users using the network adapted to withhold at least a portion of the full identity of the airline tickets until they are purchased by the users.

21. A system for purchasing airline tickets, comprising:
a network;
one or more users coupled to the network; and
a host coupled to the users using the network adapted to generalize at least a portion of the full identity of the airline tickets until they are purchased by the users.

22. A computer implemented method of purchasing products, comprising:
withholding at least a portion of the full identity of the product until after the purchase of the product.

23. A computer implemented method of purchasing products, comprising:
generalizing at least a portion of the full identity of the product until after the purchase of the product.

24. A computer program stored in a medium in a machine-readable format, comprising a computer implemented method of purchasing products, including:
withholding at least a portion of the full identity of the product until after the purchase of the product.

25. A computer program stored in a medium in a machine-readable format, comprising a computer implemented method of purchasing products, including:
generalizing at least a portion of the full identity of the product until after the purchase of the product.

26. A system for purchasing products, comprising:
a network;
one or more users coupled to the network; and
a host coupled to the users using the network adapted to withhold at least a portion of the full identity of the products until they are purchased by the users.

27. A system for purchasing products, comprising:
a network;
one or more users coupled to the network; and
a host coupled to the users using the network adapted to generalize at least a portion of the full identity of the products until they are purchased by the users.

28. A computer implemented method of purchasing airline tickets, comprising:
entering one or more desired airline travel criteria;
retrieving and displaying one or more available airline travel resources that approximately match the desired airline travel criteria, wherein at least a portion of the full identity of the airline travel resources are withheld;
purchasing one or more of the available airline travel resources; and
displaying the withheld portion of the full identity of the purchased airline travel resource;
wherein the airline travel criteria include a permissible variation in a desired travel date;
wherein the withheld portion of the full identity of the purchased airline travel resource is selected from the group consisting of the identity of the airline, the stopover airports, the departure times, the arrival times, and the flight number;
wherein the displayed available airline travel resources include a time period for departure and arrival; and
wherein the time period for departure and arrival is selected from the group consisting of morning, afternoon, evening, and overnight.

29. A computer program stored in a medium in machine readable format for a computer implemented method of purchasing airline tickets, comprising:
entering one or more desired airline travel criteria;
retrieving and displaying one or more available airline travel resources that approximately match the desired airline travel criteria, wherein at least a portion of the full identity of the airline travel resources are withheld;
purchasing one or more of the available airline travel resources; and
displaying the withheld portion of the full identity of the purchased airline travel resource;
wherein the airline travel criteria include a permissible variation in a desired travel date;
wherein the withheld portion of the full identity of the purchased airline travel resource is selected from the group consisting of the identity of the airline, the stopover airports, the departure times, the arrival times, and the flight number;
wherein the displayed available airline travel resources include a time period for departure and arrival; and
wherein the time period for departure and arrival is selected from the group consisting of morning, afternoon, evening, and overnight.

30. A system for purchasing airline tickets, comprising:
a network;
one or more users coupled to the network; and
a host coupled to the users using the network adapted to:
permit the users to enter one or more desired airline travel criteria;
retrieve and display one or more available airline travel resources that approximately match the desired airline travel criteria, wherein at least a portion of the full identity of the airline travel resources are withheld;
permit the users to purchase one or more of the available airline travel resources; and
display the withheld portion of the full identity of the purchased airline travel resource after the purchase;
wherein the airline travel criteria include a permissible variation in a desired travel date;
wherein the withheld portion of the full identity of the purchased airline travel resource is selected from the group consisting of the identity of the airline, the stopover airports, the departure times, the arrival times, and the flight number;
wherein the displayed available airline travel resources include a time period for departure and arrival; and
wherein the time period for departure and arrival is selected from the group consisting of morning, afternoon, evening, and overnight.
